(19) United States
(12) Patent Application Publication
(10) Pub. No.: US 2012/0123969 A1
(43) Pub. Date: May 17, 2012

(54) Methods and Processes of Road Use Evaluation and Regulation

(76) Inventor: Peter F. Messmer, Interlaken, NY (US)

(21) Appl. No.: 13/296,474

(22) Filed: Nov. 15, 2011

Related U.S. Application Data
(60) Provisional application No. 61/456,895, filed on Nov. 15, 2010.

(51) Int. Cl. G06F 17/00; G01F 1/00; G08G 1/00

(52) U.S. Cl. 705/400; 701/117; 73/861

(57) ABSTRACT

Methods manage the damage of heavy road users on a municipal road network through the implementation of Road Use Agreements between municipalities and heavy road users. Specifically, methods accomplish one or more purposes including, but not limited to, quantifying the in situ traffic capacity of a road, the routine traffic using the road, and the depreciation caused by that traffic, determining whether a heavy road user is regulated, and measuring and quantifying road damages by heavy users versus the normal depreciation by routine traffic. Methods determine the cost share of damage liabilities for heavy road users versus the municipal liability for capital depreciation existing prior to the activities of the heavy road users and the damage of routine traffic using the road at the same time as a heavy road user or multiple heavy road users. Methods preferably provide a regulatory chart for one or more roads.

### REFERENCE TO RELATED APPLICATIONS

This application claims one or more inventions which were disclosed in Provisional Application No. 61/456,895, filed Nov. 15, 2010, entitled “Analytical Process for Road Use Regulation Incorporating a Fishnet Analysis Method for Distinguishing Regulated and Non-Regulated Users”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the fields of road use and road use agreements. More particularly, the invention pertains to methods and processes of road use regulation.

2. Description of Related Art

A road use agreement (RUA) is a document that stipulates the terms and conditions between a municipality and a heavy road user or developer for the use of municipal roads. The issue of managing the road use activities of infrequent, but large, impact heavy road users is of great concern to municipalities and their highway agencies because of the excessive and sudden damage to the roads that can be caused, damage that can overwhelm the capabilities of the municipal highway agency.

The intention of an RUA is to protect the public highway asset and taxpayer from the excessive road use depreciation costs of the heavy road user that may otherwise be left unmitigated. A good RUA however, does not solely consider the weight of vehicles. Damage to roads is done by both numbers of traffic loads as well as the weight of vehicles. And in fact, of all traffic on the local highway network, most is within legal load parameters. Damage by large scale development, or other heavy road users, is almost always by legal loads. Furthermore, implementation of an RUA inherently possesses the difficulty of distinguishing between normal, routine truck traffic such as agricultural vehicles, service trucks, and school buses and truck traffic that is above and beyond normal traffic and which is associated with some private development effort or other form of infrequent heavy road use. The philosophy of an RUA is that a municipality and its citizens should not have to bear the fiscal responsibility for damages by private heavy road users that is beyond their highway department capabilities, acceptable standard practices and level of service provided by the current tax base and highway department assets of equipment, labor, and budget.

An RUA ultimately defines the financial remuneration to be paid to the municipality by the heavy road user, to compensate for the excessive damage done to the road, that has deprived the municipality of its funded road capacity and which exceeds the capabilities of the municipality, in terms of cost and highway agency capabilities, to mitigate. A road use agreement also includes articles that require safety analysis of proposed haul routes and maintenance of haul routes during use. However, in order to accomplish the intentions mentioned, an RUA needs a fair analytical procedure. This procedure must be able to quantify existing routine levels of traffic and quantify damages pre-existing prior to use by a heavy road user or multiple heavy road users. It must be able to quantify damages of a heavy road user or multiple heavy road users conducting activities on the road simultaneously, including the normal and routine traffic using the road. Finally, when the damages have been quantified there must be an equitable way to distribute cost liability for the damage to all of the users, including the municipality for the damages by normal traffic.

### SUMMARY OF THE INVENTION

Methods manage the damage of heavy road users on a municipal road network through the implementation of Road Use Agreements between municipalities and heavy road users. Specifically, methods accomplish one or more purposes including, but not limited to, quantifying the in situ traffic capacity of a road, the routine traffic using the road, and the depreciation caused by that traffic, determining whether a heavy road user is regulated, and measuring and quantifying road damages by heavy users versus the normal depreciation by routine traffic. Methods determine the cost share of damage liabilities for heavy road users versus the municipal liability for capital depreciation existing prior to the activities of the heavy road users and the damage of routine traffic using the road at the same time as a heavy road user or multiple heavy road users. Methods preferably provide a regulatory chart for one or more roads.

### BRIEF DESCRIPTION OF THE DRAWINGS

FIG. 1 shows a pavement life cycle in an embodiment of the present invention.

FIG. 2 shows a fishnet ESAL margin concept in an embodiment of the present invention.

FIG. 3 shows a first iteration of a lifetime design ESAL versus damage in an embodiment of the present invention.

FIG. 4 shows a second iteration of a lifetime design ESAL versus damage in an embodiment of the present invention.

FIG. 5 shows an annual baseline ESAL versus damage with a fishnet margin of 0.273 in an embodiment of the present invention.

FIG. 6 shows another annual baseline ESAL versus damage with a fishnet margin of 0.273 in an embodiment of the present invention.

FIG. 7 shows a fishnet damage chart for a one-year period in an embodiment of the present invention.

FIG. 8 shows a first gravel road damage chart in an embodiment of the present invention.

FIG. 9 shows a second gravel road damage chart in an embodiment of the present invention.

FIG. 10 shows a third gravel road damage chart in an embodiment of the present invention.

FIG. 11 shows a fourth gravel road damage chart in an embodiment of the present invention.

### DETAILED DESCRIPTION OF THE INVENTION

In some embodiments, a Fishnet Analysis Method produces a graphical chart, and the related calculation procedures to construct the Chart, as a tool for the determination of damage shares and cost liabilities among all of the users of a road, including the heavy road users and the municipality, for a one-year accounting period.

In some embodiments, a Fishnet Analysis Method and Regulatory Chart is derived from the application of the fundamentals of pavement structural design, using the “American Association of State Highway Transportation Officials (AASHTO) Guide for the Design of Pavement Structures”, copyright 1993, Washington D.C., hereby incorporated herein by reference. Specifically, AASHTO empirical design calculations for flexible asphalt pavements and aggregate surfaced roads may be applied in a Fishnet Analysis Method to create a Fishnet Chart. The AASHTO empirical design method for flexible pavements depends on the AASHTO concept of Structural Number. In some embodiments, a Fishnet Analytical Approach determines and uses an in situ Structural Number for a given road being analyzed. The implementation of forensic pavement investigations, sampling of in situ materials, and laboratory testing of the specimens lead to the final calculations to determine the in situ Structural Number. This forensic procedure employs geotechnical engineering practices and nationally accepted laboratory testing procedures established by the American Society for the Testing of Materials (ASTM) and AASHTO. Standard laboratory tests are used to develop data necessary to calculate AASHTO Structural Numbers. These tests and procedures include, for example, sieve and wash analysis, Atterberg limits, California Bearing Ratio, and Marshall Mix Design procedures.

Furthermore, an RUA requires a pre-use and post-use inspection to record and prove damages for the purposes of defining the needed mitigation technique after the heavy road use activities are ended. The pre-use inspection is preferably part of the forensic investigation already mentioned. The Fishnet Analysis Method preferably also incorporates the more general concepts of pavement management with respect to defining the stages of depreciation of a flexible asphalt pavement or an aggregate surfaced road. These stages include reconstruction, rehabilitation, preventive maintenance, and routine maintenance. The method preferably differentiates the calculation of cost liability, depending on the state of depreciation of the road, into two general liability cost share approaches, one for capital repairs and another for maintenance repairs. The method also preferably uses the results of the measurement and quantification of traffic loading. The method quantifies traffic using the AASHTO concept of Equivalent Single 18 kip Axle Loads (ESALs). In order to do this, the Fishnet Method also preferably uses data from traffic counting with state of the art technology that can distinguish between vehicles and assign vehicles to the 13 standard FHWA vehicle classes. Finally, the Fishnet Analysis is preferably applied to a road surface type. Therefore, the specific road must be distinguished among the various common pavement material classes routinely encountered among the networks of roads for a local municipality. Local roads, based on the state of the practice, are defined and categorized into five general material classes to accomplish the calculations. These classes include thick bituminous pavements, thin bituminous pavements, and surface treatments, aggregate surfaced roads, and earth roads. These material classifications of road type are based on the typical materials and practices of the paving industry, including the hot mix asphalt concrete industry as well as the liquid asphalt emulsion industry.

The process, referred to herein as the Fishnet Analytical Method, preferably analyzes road use for the purpose of regulating heavy users so as to manage damage costs incurred by municipalities. The method preferably provides an analytical approach that governs the determination as to when a road user or developer is regulated, including the essential mathematical methodology so that a municipality, when incorporating this process in a “Road Use Agreement” enacted as a referenced portion of adopted statutes, can provide for the fair and equitable assessment of road damage and the liabilities for such damage.

The concepts of the Fishnet Analysis Method are illustrated for the purposes of defining damages of road users and determining which heavy road users should be regulated. This analysis is preferably based on the Structural Capacity of the last major treatment done on the existing road and the base line traffic using the road. From this basic information, the life time ESAL capacity of the road may be determined using an AASHTO pavement design equation. This capacity may be calculated for an acceptable range of reliability which in turn generates the concept of margin. The margin may then be expressed as a function of a damage coefficient. The damage coefficient is used to establish an annual margin of damage. Developers are then allowed to traffic the road if their ESAL damage is within the margin, which is further modified by a permissivity factor. This leads to the concepts of regulated and permissive margins, based on the permissivity factor. Calculation methods preferably determine damage liability shares and capital depreciation liability shares for both municipal and heavy road users. These shares are the final numbers used to determine how damage liability costs are fairly and accurately assigned to all parties using the haul route, including the municipal baseline traffic. The fishnet procedures herein may be applied to analysis of both paved and gravel roads. Additionally, thin surface treatment roads may be treated using a combination of the paved and gravel roads procedures.

Alternatively, the margin may be calculated as a percentage of the measured baseline traffic pattern for the road. In some embodiments, the margin is in the range of 5% to 20% of the baseline traffic pattern. In some embodiments, the margin is 10% of the baseline traffic pattern.

In some embodiments, a method classifies a road into one of the following classifications for purposes of executing one or more fishnet analysis procedures: thick bituminous pavement, thin bituminous pavement, surface treatment, gravel road, and earth road.

In some embodiments, a last major treatment structural number forensic and calculation procedure for thick bituminous pavements includes defining the term “last major treatment”, performing test pit procedures, performing pavement coring procedures, identifying a last major treatment, performing specimen tests, and performing a last major treatment representative structural number calculation.

In some embodiments, a last major treatment structural number forensic and calculation procedure for thin bituminous pavements includes defining the term “last major treatment”, performing test pit procedures, performing pavement coring procedures, identifying a last major treatment, performing specimen tests, and performing a last major treatment representative structural number calculation.

In some embodiments, a last major treatment structural number forensic and calculation procedure for surface treatment pavements includes defining the term “last major treatment”, performing test pit procedures, performing pavement coring procedures, identifying a last major treatment, performing specimen tests, and performing a last major treatment representative structural number calculation.

In some embodiments, a procedure determines the time of last major treatment for thick bituminous pavements, thin bituminous pavements, or surface treatments.

In some embodiments, a procedure for pre-use and post-use pavement inspection for road use agreements includes measuring a rut depth, measuring a cross slope, a video logging procedures, and an international roughness measurement procedure.

In some embodiments, a procedure calculates municipality wide 18-kip equivalent single axle load (ESAL) equivalency factors for low, medium, and high traffic categories.

In some embodiments, a current base line traffic annual ESALs value is calculated for all road classes.

In some embodiments, a time of last major treatment annual ESALs value is calculated for paved road classes.

In some embodiments, a lifetime design ESALs value is calculated for the last major treatment for paved road classes.

In some embodiments, a paved road fishnet analysis for road use agreements based on the structural number of the last major treatment includes defining the concepts and terms used in the fishnet analysis method, calculating road user damages, calculating municipal base line traffic damages, calculating thin and thick bituminous pavement lifetime ESALs margins, calculating thick bituminous pavement lifetime damage margins, calculating thin bituminous pavement lifetime damage margins, calculating thick bituminous pavement annual damage margins, calculating thin bituminous pavement annual damage margins, defining a paved road permissivity factor and selecting values for thin and thick bituminous pavements, and constructing a thin or thick paved road fishnet regulatory chart. The analysis also includes calculating a paved road regulated versus permissive margin for thin and thick bituminous pavements to determine a regulated damage margin and a permissible damage margin. The analysis further includes calculating paved road regulated damages for thin and thick bituminous pavements to determine regulated road user damage off set credits, a regulated road user total damage liability, and a regulated road user net damage liability share.

The analysis also includes calculating paved road permissible damages for thin and thick bituminous pavements to determine an excess permissible damage to be added to a municipal damage liability, a permissible damage credit to be added to the regulated margin and rationed to the regulated road users as an off set credit, a municipal baseline damage liability, and a municipal net damage liability share.

In some embodiments, a gravel road fishnet analysis method for road use agreements based on an in situ present structural number includes defining concepts and terms to explain the concepts, calculating road user damages, calculating municipal base line traffic damages, calculating gravel road annual damage margin, defining a gravel road permissivity factor and selecting of values, constructing a gravel road fishnet regulatory chart, and calculating a gravel road regulated versus permissible damage margin calculation procedure to determine a regulated damage margin and a permissible damage margin. The analysis also includes calculating gravel road regulated damages to determine regulated road user damage off set credits, a regulated road user total damage liability, and a regulated road user net damage liability share. The analysis further includes calculating gravel road permissible damages to determine excess permissible damage to be added to a municipal damage liability, a permissible damage credit to be added to a regulated margin and rationed to regulated road users as an off set credit, a municipal baseline damage liability, and a municipal net damage liability share.

In some embodiments, a surface treatment roads fishnet analysis for road use agreements based on a structural number of a last major treatment includes defining concepts and terms to explain the concepts, calculating road user damages, calculating municipal base line traffic damages, defining a permissivity factor and selecting values, calculating a lifetime damage margin for ΔPSI, calculating an annual damage margin for ΔPSI, calculating an annual damage margin calculation procedure for rut depth, selecting controlling criteria, ΔPSI, or rut depth, and constructing a surface treatment road fishnet regulatory chart for the controlling criteria. The analysis also includes calculating a treatment road regulated versus permissible damage margin to determine a regulated damage margin and a permissible damage margin. The analysis further includes calculating regulated damage shares to determine regulated road user damage off set credits, a regulated road user total damage liability, and a regulated road user net damage liability share. The analysis also includes calculating permissible damages to determine an excess permissible damage to be added to the municipal damage liability, a permissible damage credit to be added to a regulated margin and rationed to regulated road users as an off set credit, a municipal baseline damage liability, and a municipal net damage liability share.

In some embodiments, a method of calculating a thin, thick or surface treatment paved roads capital depreciation liability share calculation procedure based on a structural number includes defining the concepts and terms to explain the concepts, calculating a road user capital depreciation liability share, and calculating a municipality capital depreciation liability share calculation.

In some embodiments, a method of calculating a gravel roads capital depreciation liability share based on a structural number includes defining the concepts and terms to explain the concepts, calculating a road user capital depreciation liability share, and calculating a municipality capital depreciation liability share calculation.

In some embodiments, a capital repair total cost share for paved and gravel roads of a regulated heavy road user is calculated as a function of a net damage liability share and a capital depreciation liability share.

In some embodiments, a paved road post-use maintenance repair total cost share of a heavy road user is determined as a function of net damage liability share.

In some embodiments, a paved road maintenance policy governing maintenance requirements during use by a regulated heavy road user is determined

In some embodiments, a gravel road maintenance policy governing maintenance requirements during and after use by a regulated heavy road user is determined

In some embodiments, an analytical procedure determines if a paved road should be upgraded prior to a regulated road user activity.

In some embodiments, an analytical procedure determines if a gravel road should be upgraded prior to a regulated road user activity.

In some embodiments, a policy on the upgrade cost liability and responsibility of regulated heavy road users is established. This narrative policy stipulates the full responsibility of regulated heavy road users to pay for upgrades in their entirety. It preferably establishes an exception when a proposed haul route has already reached terminal consumption of all structural capacity and which has been previously scheduled for capital repairs prior to the declaration of the regulated heavy road user activity.

In some embodiments, an agricultural road use agreement exemption policy is established. This narrative policy exempts all agricultural traffic from road use agreement regulation.

In some embodiments, a forester and logger road use agreement partial exemption policy is established. This narrative policy provides partial exemption for loggers from a road use agreement, subject to weather conditions.

In some embodiments, a flow chart of a fishnet analysis illustrates the execution of the steps of the fishnet analysis. This flow chart shows how the elements of a fishnet analysis relate to each other and a logical order in which they must be done.

### SUPPORTING CONCEPTS AND DEFINITIONS

Certain terms from the field of highway engineering and pavement management are used herein, as well as many original terms to explain the concepts and procedures used in the Fishnet Analysis Method. This section explains and defines some of these terms. Other concepts and definitions not defined in this second are introduced and explained elsewhere.

### Pavement Management Concepts and Terminology

Further discussion of Fishnet Analysis Methods includes concepts of pavement management. Pavement terminology is often used with somewhat different emphasis on meanings. For the purposes of the discussion herein, the following explanation and definitions are presented for clarification of terminology used in these procedures.

### Road Types

Flexible pavements include pavements composed of aggregates and bitumen binder and aggregate surfaced roads. Flexible pavements do not include Portland cement pavements. However, the AASHTO design method does include a Portland cement design application and the methods described herein may be adapted for it. Also, the fishnet analysis, as described herein, does not apply to earth roads.

Flexible Bituminous Pavements may be classified in two general categories, including asphalt concrete and bituminous surface treatments. Asphalt Concrete is produced as both a Hot Mix material and a Cold Mix material.

Hot mix is produced in a stationary plant and incorporates sized and proportioned aggregates mixed together with carefully measured amounts of asphalt cement binder. Hot mix is produced in accordance with stringent quality control measures that are based on mix designs. Mix designs in the past were commonly based on the Marshall method or the Hveem method, to name two common methods. Currently, Superpave mix design methods have been widely implemented.

Cold mix is produced in the field, in portable plants called ‘pug-mills’ or through mobile pavers that have a pug-mill on board, referred to as ‘mix-pavers’. A contemporary recycled form of Cold mix is also produced in situ on the roadway through means of traveling cold-in-place recycle trains (CIPR).

Thin Bituminous Pavements include a genre of treatments collectively called Surface Treatments. Examples are chip seals, slurry seal, and cape seal, and even a 1-inch layer of hot mix is considered a surface treatment, because it possesses so little inherent strength in terms of load carrying capacity. Chip seals are applications of asphalt emulsion binder covered with chip stone. Slurry seal is a mixture of sand and quick setting emulsion. Cape seals are a double application including a first layer that is a chip seal followed by a slurry seal. Built up Bituminous Pavements include multiple applications of surface treatments.

Thick Asphalt Concrete Pavements include a layer, or multiple layers of cold mix or hot mix asphalt concrete. Such pavements can also include layers of surface treatments mixed in.

Gravel roads are built by the shaping and grading of the natural ground, or sub-grade, which is then paved with one or more layers of aggregate. Sometimes a sub-base of a large top-size bank run is placed first, followed by a layer of finer crushed or screened gravel as the driving surface. Sometimes a gravel road includes only a single layer of graded and crushed or screened aggregate.

Earth roads are built by the shaping and grading of the natural ground. The topsoil is usually removed until the underlying coarser ‘hardpan’ materials are exposed. The road is then utilized in that state with no additional gravel added. Since there is no pavement structure to evaluate, earth roads generally require complete upgrades prior to use by heavy users. Therefore they are not included in the fishnet analysis procedures described herein.

### Road Life Cycle

The materials placed to build a paved or gravel road produce a structure that supports traffic loads and spreads the stresses and strains over a larger region of the underlying sub-grade or natural ground the road is built upon. This structure has an inherent life cycle based on the thickness and number of layers, the types of materials, such as gravel or asphalt, the ground upon which the road is built and the traffic expected to use the road. Gravel base layers serve the important function of supporting the more expensive asphalt materials on top and therefore the quality of base materials is of great importance. Similarly, the quality of gravel on gravel surfaced roads greatly impacts the performance of the road. Sometimes roads are designed using a mathematical model or method. At other times they are simply built by common sense and judgment. Higher use roads such as interstate and intrastate highways are often based on a design method such as the AASHTO pavement design method. Local roads are often built by judgment only. It is local roads, often built by judgment, that are in the greatest need of protection by a Road Use Agreement.

### Maintenance Treatment Phases

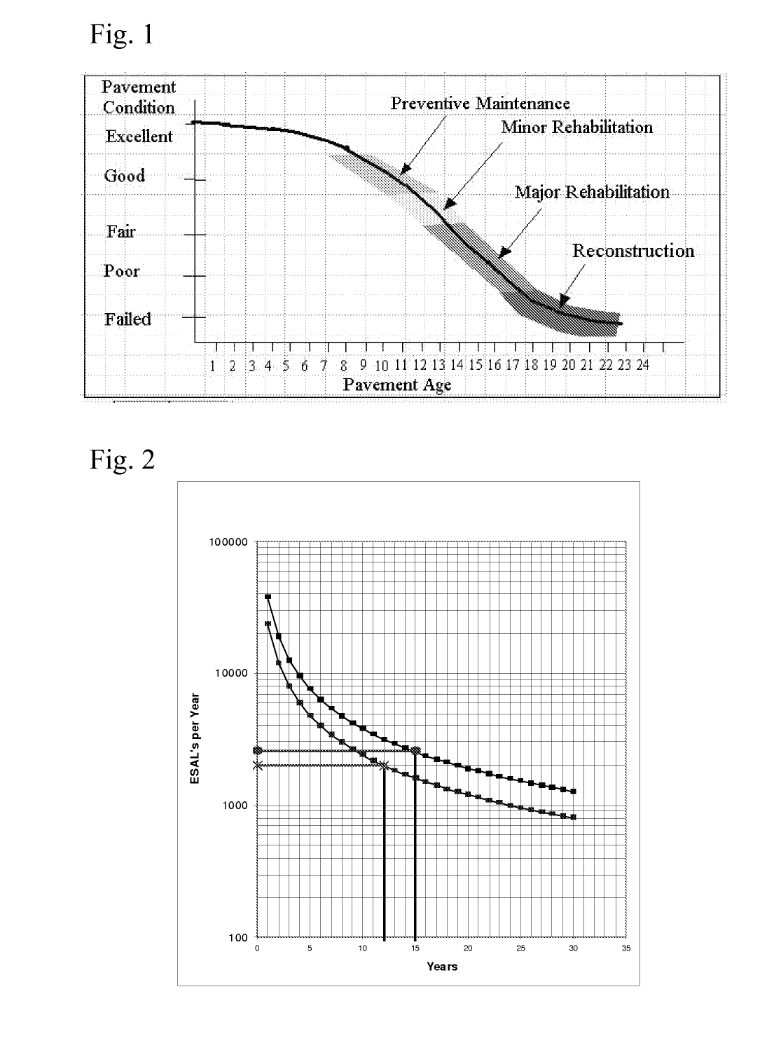

Both gravel and paved roads go through a depreciation life cycle. FIG. 1 schematically shows the concept of life cycle for a paved road. Each phase of the life cycle requires action of an increasing effort as well as increasing cost to maintain the road. The basic stages of life for a paved road include, new (no action needed), routine maintenance, preventive maintenance, minor rehabilitation, major rehabilitation, and reconstruction. The same basic stages can be associated with a gravel road except that minor rehabilitation and major rehabilitation can be combined and thought of as just rehabilitation. Once a road has progressed through these stages and it is reconstructed, the life cycle starts over again. The definitions of these terms for paved roads and gravel roads follow.

### Paved Roads

Routine Maintenance—The pavement is fairly new and only requires minor repairs such as patching or repair of cracks through crack sealing.

Preventive Maintenance Phase—The pavement has aged to the 4- to 9-year point. The sun has oxidized and hardened the oils in the asphalt binder, and there are fine cracks starting in many places. Additionally, the surface of the road may be polished and slippery. Surface treatments are used to mitigate these problems. Surface treatments may be applied about every 4-5 years during this phase.

Minor rehabilitation—The pavement is generally about 10-15 years old and it has more severe outbursts of cracks which must be treated with patch material or crack seal material. Furthermore, the pavement may need some minor rut filling, true, and leveling to restore the cross section shape and ride-ability. A thin pavement or surface treatment is often placed over the entire road after the repairs to cover the patches and crack seal material and to accomplish rut-filling, true, and leveling and to restore a uniform driving surface.

Major rehabilitation—The pavement is generally about 12-20 years old and has experienced much of the traffic carrying capacity it can handle. Its flexibility is greatly reduced due to aging of the asphalt binder and cracking is somewhat extensive, however, there is still useful life in the pavement and the base layers underneath have not given out. Pavement in this condition may be reinforced with thick asphalt overlays of cold mix or hot mix asphalt concrete during this major rehabilitation phase.

Reconstruction—The asphalt pavement layers have been mostly consumed. The road surface has extensive and severe cracking and the road cross section shows indications of base failure by visible rutting, bumps and depressions from use and processes such as frost heave. In this case both the base and the asphalt pavement need to be recycled or replaced.

### Gravel Roads

For gravel roads the pavement life-cycle is dictated by how long the gravel stays on the road. A number of factors work to remove the gravel, including traffic, water, wind, and temperature fluctuations. As vehicles travel the gravel road, they create dust. Wind blows away the dust and larger gravel pieces are left behind. These, in turn can be kicked off the road by vehicle tires. This traffic-dust-wind erosion cycle may cause up to an inch of gravel loss a year if it is not mitigated. Also, gravel may be lost by merging with soft clayey sub-grades. This happens as a result of the dynamic forces of traffic especially in combination with the effects of freeze-thaw in the winter and softness in the spring and fall when the water table is high. So, in the long run, major rehabilitation restores lost gravel. Reconstruction reinforces or increases the structural capacity of the road with significantly more gravel when large amounts of gravel loss have accumulated over the years, in the absence of major rehabilitation, or if traffic increases demand more gravel structure. For a gravel road routine maintenance and preventive maintenance on an annual basis are keys to success. These activities prevent loss of gravel and may greatly extend the life of a gravel layer, thereby reducing overall road maintenance and capital costs.

Routine Maintenance—This includes re-grading and reshaping the road surface, which is typically done at least once a year, often twice a year on higher trafficked roads, and sometimes three or four times a year on high trafficked roads where the highway agency has the resources to execute such frequent maintenance. Routine maintenance also includes repairing local soft spots, potholes, and corrugations or wash-boarding which often happens on hill sections.

Preventive Maintenance—This includes various forms of dust control to prevent the erosion and loss of gravel. Applications of various salt brines of calcium chloride, sodium chloride, or magnesium chloride may be used. Asphalt Emulsion dust oil may also be used.

Rehabilitation—This is an application of a new layer of gravel on the road, often ranging in thickness from 3 to 8 inches. The highway agency resources and traffic on the road usually dictate how much and how often re-graveling is done.

Reconstruction—This is necessary to upgrade an earth road to a gravel road. It is also needed when a gravel road is widened. And finally, if gravel road maintenance has been under funded or neglected, a gravel road may lose so much of its gravel that it reverts, essentially to an earth road and shows signs of rutting and deformation. This situation requires a new full depth application of gravel, either with a sub-base layer and a surface layer or a thick single layer.

### Concepts and Terminology Used in a Fishnet Analysis

The Fishnet concepts described herein utilize the following important concepts and elements, some of which are originally created to explain the fishnet procedures and some of which are terms used in the AASHTO empirical pavement design procedures.

Heavy Road User—A road user who generates a large number of heavy loads, which might overwhelm the structural capacity of a local road, and may significantly foreshorten the life of the road. Heavy road users include, but are not limited to, a developer or a logger.

Developer—A heavy road user engaged in a construction activity of some kind.

Declared Heavy Road User—A heavy road user or developer whose activities require some form of regulatory permit or action, such as a State Environmental permit (NYS DEC), a United States Corp of Engineer Permit, A SEQR action, and Environmental Impact State, an historic review (NYS SHPO), or a local permit for logging. A Declared Heavy Road User may be subject to the Fishnet Analysis Method to make a determination of whether or not they become regulated.

Regulated Heavy Road User—A heavy user/developer determined by the fishnet analysis method to be regulated.

Regulated Traffic—Regulated traffic is traffic that exceeds baseline traffic and is generated from the activities of a Regulated Heavy Road User. It is characterized especially by excessive numbers of heavy loads (not necessarily overweight loads) that may quickly exceed the load carrying capacity of a local road and deteriorate the road so quickly that the base line traffic of local and surrounding community users are deprived of the asset paid for by local tax revenue. Therefore, this traffic is regulated in order to quantify the damage it does and to pass on the costs of the damage to the developers/heavy road users who foreshortened the life of the pavement system paid for by the general tax-paying public.

Regulated Haul Route—A road with a structural capacity inadequate to accommodate the proposed traffic of a declared heavy road user, as determined by a fishnet analysis method.

Municipal Base Line Traffic—This is the resident and routine traffic normally using a road. This traffic is generated by the day-to-day community activities ongoing within and about the roadway corridor. In contrast, there are times when large development projects generate high intensity truck traffic for short periods of time that far exceed the base line traffic. This high intensity, short duration traffic is not considered to be part of the base line traffic. The Fishnet analytical procedures herein provide an analytical method to differentiate between baseline traffic and high intensity traffic.

Non Discriminatory—An RUA cannot single out any industry, with respect to development and road use. It must be nondiscriminatory. It must identify large impact projects by number and weight of vehicles, regardless of the industry that generates the traffic.

Depreciation Based—An RUA must quantify and document the damage to a road done by the developer or user that is being regulated. The damage that is being quantified must be differentiated from the normal depreciation of the road by the routine, base line traffic.

Structural Number—The Road Structural Capacity of a proposed haul route is quantified using the AASHTO Structural Number (SN) concept. The Design SN is calculated, according to the AASHTO empirical design method, as a function of the desired design life, the baseline traffic the road serves, the strength of the natural ground the road is built upon, and a failure criteria defined by an Initial Serviceability Index and a Terminal Serviceability Index. There are also a Reliability variable and a Standard Deviation variable in the equation. Then, independent of the AASHTO empirical equation calculated Design Structural Number there is the concept of the roadbed SN. The SN of the roadbed materials is determined from the following AASHTO equation:

SN=a₁d₁t₁+a₂d₂t₂+a₃d₃t₃₊aᵢdᵢtᵢ (1)

where a=layer strength coefficient, d=layer drainage coefficient, and t=layer thickness.

In order to ‘balance’ a design the road bed SN, given by the formula above, must equal or exceed the AASHTO empirical equation Design SN based on the major input variables mentioned above.

Serviceability Index—Failure, in the AASHTO method, is determined by the ride quality of the road. The AASHTO method defines this with a variable called Pavement Serviceability Index (PSI).

Reliability of Design—The AASHTO design method includes a statistical factor for reliability of the design. This number is used as a statistical means of predicting the chance that the Design SN yielded by the AASHTO equation will achieve the design life, for the design input variables used.

Equivalent Single Axle Load (ESAL)—Traffic Load Assessment is made in units of equivalent single 18 kip axle loads, in accordance with the AASHTO methodology.

Annual Daily Traffic (ADT)—Traffic counts distinguish the ADT in terms of the number and type of vehicles using the roadway, typically in accordance with the thirteen FHWA traffic classes.

Load Equivalency Factor (LEF)—This is a factor used to convert various axle weights to 18 kip ESALs. These conversions are used to compute the ESALs per vehicle for a given vehicle class axle and weight distribution configuration. This conversion is done by the AASHTO load equivalency equations for single, tandem, and tridem axles. The AASHTO Guide for the Design of Pavement Structures includes tables with the Load Equivalency Factors already computed, because the formulas are cumbersome.

Sub-grade Resilient Modulus (MR)—Resilient Modulus is a measure, in units of psi, of the strength of the natural sub-grade. It is a very significant variable in the paved and gravel road AASHTO design equations. The same road built over strong gravel or rock will last much longer than if it were built on a high plasticity clay.

Paved Roads Definitions—For the purposes of this analysis, local roads composed of some form of bituminous pavement are categorized in one of three groups including: Bituminous Surface Treatments, Thin Asphalt Concrete Pavements, and Thick Asphalt Concrete Pavements.

Bituminous Surface Treatments—Roads composed of bituminous layers 1-inch thick or less, and generally composed of built up layers of asphalt emulsion or asphalt cutback binders and chip stone of various sizes, commonly referred to as Chip Seals. Such roads are often called chip seal roads.

Thin Asphalt Concrete Pavements—These roads are composed of layers of chip seals that have built up to exceed 1-inch but are less than 3 inches thick.

Thick Asphalt Concrete—These roads are composed of at least one thick layer of cold mix or hot mix asphalt concrete and may also include other layers of surface treatments (chip seals, slurry seals etc) such that the combined thickness exceeds three inches.

Last Major Treatment (LMT) for paved roads—The concept of the “Last Major Treatment” applies to bituminous or asphalt concrete roads. It is the last major asphalt treatment constructed.

Time of the Last Major Treatment—This is the point in time when the last major treatment was placed on the road. It is determined differently depending on the type of bituminous pavement. In general, for surface treatment roads and thin bituminous pavements the time of the LMT is set at the middle point in time of the period of years over which the surface treatments were placed. This time can also be established through information gathered from the highway agency. For thick asphalt concrete roads, the time of the LMT is set for the year when the very last thick layer of asphalt concrete (cold mix or hot mix) was placed. For Gravel roads the LMT concept is not used, because a gravel road analysis is done only on an annual basis, considering the annual ESALs of baseline traffic compared to the proposed developer traffic for the year.

Design ESALs of the Last Major Treatment (E_{L})—This is the number of ESALs the in situ Structural Number of the LMT is expected to support over its expected design life. It is determined by using the in situ SN of the LMT in the AASHTO flexible pavement design equation.

Expected Design Life (DL_{E})—This is the design life of the LMT. It is determined as a function of the E_{L}, the baseline annual ESALs at the time of the LMT, and a traffic growth rate.

The Fishnet Analysis Method—The analytical method used to evaluate the potential damage of the declared heavy user traffic to the proposed haul route relative to the baseline traffic. The fishnet analysis considers paved roads at the point of time of the LMT. The lifetime ESAL capacity and DL_{E} of the road are determined based on the SN of the road at the point in time of the LMT. The proposed heavy road user ESALs are then evaluated in comparison to the ESAL capacity of the LMT still in the process of being depreciated and consumed. For gravel roads, the analysis is limited to the current year of the heavy road use activity only. The Fishnet Analysis Method is preferably used to construct a Fishnet Regulatory Chart used for the calculation of Total Cost Shares.

Damage Liability Share—This is the percent of damage, calculated for a one-year regulatory period, caused by any single Declared Heavy Road User, regulated or non-regulated, as a percent of the total damage of all Declared Heavy Road Users and the municipal baseline traffic.

Capital Depreciation Liability Share—This is the amount of structural capacity of the Last Major Treatment consumed by any given road user, which is any Declared Heavy Road User or the Municipality itself. It is preferably expressed as a percent of the depreciation of the road pavement Structural Number.

Capital Repair Total Cost Share—The percent of the cost of a post-use capital repair that a Regulated Heavy Road User is liable for. It is a function of the Damage Liability Share and the Capital Depreciation Liability Share.

Paved Road Post-Use Maintenance Repair Total Cost Share—The percent of the cost of a post-use maintenance repair that a Regulated Heavy Road User is liable for. It is a function of the Damage Liability Share.

### The Fishnet Concept

The general concept of the Fishnet method is to catch ‘big fish’, release ‘little fish’, and regulate ‘keepers’. ‘Big fish’, as used herein, are declared heavy road users that generate large numbers of ESALs in short periods of time that significantly foreshorten the expected service life of a proposed haul route. ‘Little fish’, as used herein, are other declared heavy road users that generate modest numbers of ESALs but that do not significantly foreshorten the expected service life of the proposed haul route. The fish net analysis procedure first catches both ‘big’ and ‘little’ declared heavy road users. It then releases ‘little’ declared heavy road users after analysis indicates their use will not foreshorten the expected service life beyond acceptable limits defined by the analysis procedure. The analysis procedure determines a break point between declared heavy road users that should be ‘kept’ and regulated versus road users that should be ‘released’ and need not be regulated. For paved and gravel roads, this fishnet method preferably uses the concept of margin. Margin may be expressed in units of ESALs or in a unit-less coefficient described herein as a damage coefficient.

### ESAL Margin

The idea of a margin is derived from the fact that road structural design by the AASHTO method is an empirical one and therefore not precise. That is, the variables involved in the AASHTO empirical equation have reasonable ranges of values. Minor and reasonable changes to these variables will affect the Design Life ESALs calculated by the equation. The concept of Margin (in units of ESALs) is derived from an acceptable range of these variables that return a variation in Design life ESALs.

Precisely because the AASHTO design method is empirical, and because minor variations of the input values generate significant differences in the calculated lifetime ESALs, the design of pavement structures with the AASHTO method does not need nor include the concept of safety factors. Instead the method uses a Reliability variable. This variable is a statistical factor used to establish the risk level the designer is willing to accept regarding the probability of his design actually reaching the lifetime ESALs calculated by the equation, with the input values used. Naturally, the designer or the pavement owner has an opportunity to set the Reliability factor at whatever is desired. The impact is that the higher the Reliability factor, the lower the life time Design ESALs returned by the AASHTO flexible pavement design equation. For example, a Reliability factor of 95% in the AASHTO equation returns a significantly lower number of lifetime Design ESALs than a Reliability factor of 85%. Furthermore, it may be reasonable to select a number within a range of Reliability for a road design depending on the details of the particular road design. For example, for very low volume residential roads a range of Reliability between 75% and 85% may be acceptable. For a very high volume arterial road, in an urban environment a range of 90% to 95% may be acceptable. That is, for higher volume roads, it may be desirable to set the Reliability value higher, because the highway agency may want more certainty that they will not have to return to that corridor for major rehabilitation or reconstruction any sooner than absolutely necessary for reasons such as the disruption to a large number of motorists and costs of traffic control.

Another important concept of the AASHTO design equation is the Serviceability Index. The AASHTO method includes an Initial Serviceability Index and a Terminal Serviceability Index. The Serviceability Index is a numerical score on a scale of 1 to 5 that represents the ride quality of a road. In the development of the empirical AASHTO, design equation test roads were constructed. These roads were trafficked by numerous vehicle loads, and the ride quality was rated periodically by a panel of judges who also rode over the road sections to judge them. Generally, new pavements are given an Initial Serviceability Index of 4.2 to 4.5 with the idea that no ride is perfectly smooth. It is then the designer's choice as to where to set the Terminal Serviceability Index. For example for low volume roads it might be set at 2.0. For a collector road it might be set at 2.5. The difference between the Initial Serviceability Index and the Terminal Serviceability Index is described herein as the Change in Pavement Serviceability Index (ΔPSI). The AASHTO equation returns the lifetime design ESALs that render the selected ΔPSI for a specified design life. The Terminal Serviceability Index value may also be a matter of judgment. It too can be set at various numbers by reasonable judgment. This is another adjustment factor by which the AASHTO design equation can accommodate the issue of defining failure.

Either the concept of reliability or ΔPSI can be used to establish an ESAL Capacity Margin. For example, if Reliability is used a design can be done twice, for a given road, using two values for Reliability. These two Reliability values will return two lifetime ESALs for the road. The difference between these two values is the ESAL Capacity Margin. In one embodiment, a Reliability range of 85% to 90% is acceptable to the highway agency for the design of a particular collector road. All of the other input variables for the design are established, including the sub-grade resilient modulus, the Structural Number of the layered pavement system to be built, the standard deviation, and the initial and terminal serviceability indexes. The same values are used for these variables in the AASHTO paved roads empirical design equation (reference the AASHTO Guide for the Design of Pavement Structures, copyright 1993), while only the Reliability is changed. The equation may be solved for a Reliability of 85% and then again for a Reliability of 90% to establish a Margin. Suppose that the Reliability of 85% yields a life time ESALs of 250,000 while the 90% Reliability yields a life time ESALs of 200,000. The difference is 50,000. That means that the municipality is willing to accept a variation of 20% in the overall lifetime ESALs. Since they are willing to accept a minimum of a 200,000 ESAL capacity for the road, the extra 50,000 ESAL Margin gained by their lowest acceptable Reliability provides an excess and discretionary Margin of Capacity. This may be considered analogous to the idea of a 20% factor of safety. It is this Margin that provides the excess capacity that may be reserved for use by the declared heavy road users. However, if this capacity is exceeded, the municipality is losing actual capacity intended for their baseline traffic. Therefore, the lifetime margin may be considered like a bank account of discretionary, excess capacity. This margin may be rationed by dividing it by the years of life of the road design and allowing only that amount per year as the annual ESAL Margin available for declared heavy road users that year. Therefore this Margin provides the basis to develop a fishnet ‘opening’ to be used for regulation. Declared heavy road users that pass through such a regulatory net ‘opening’ would be non-regulated.

Alternatively, the margin may be calculated as a percentage of the measured baseline traffic pattern for the road. In such embodiments, the baseline traffic pattern for the road is preferably determined empirically. In some embodiments, the margin is in the range of 5% to 20% of the baseline traffic pattern. In some embodiments, the margin is 10% of the baseline traffic pattern.

Furthermore, there is the question of how many declared heavy road users are anticipated to use the road in the analysis period of say one year. If it is only one, then the full Margin is assumed to be available for that user. If a declared heavy road user is expected only once in several years then some multiple, say a multiplier of 2 or 3 may be applied to the Margin in a given year, thus allowing more heavy use ESALs in the given analysis period, with the idea that there will be successive periods with no declared heavy road users. Similarly, if multiple declared heavy road users per year are expected, then the Margin may be reduced by some multiplier that is less than 1, say 0.5 or 0.33. This closes the opening of the fishnet and allows fewer ESALs per heavy road user, thus forcing more heavy users to be regulated and liable for damages. This multiplier, which may be 1, less than 1, or greater than 1, is defined as the Permissivity Factor.

The Margin concept is illustrated in FIG. 2 using the Reliability Factor to generate the margin value. In the case in FIG. 2, the margin is about 600 ESALs per year, where the upper curve represents a reliability of 65% and the lower curve a reliability of 80%. The total ESAL capacity of the road calculated by the AASHTO design equation is 38,000 and 24,000 ESALs respectively for the upper (65% Reliability) and lower (80% Reliability) curves. Referencing the 65% Reliability curve, if the road experiences all 38,000 ESALs in one year it has only a one year life, which is the top point of the curve. The rest of the curve is generated by taking the total design ESALs and dividing it by years, from the x-axis, and plotting the corresponding ESALs per year on the y-axis. For the given ADT on the road, the life of the road varies from 12 to 15 years for the 80% and 65% reliabilities, respectively. The 600 ESAL margin appears in FIG. 2 as the difference on the y-axis between the two horizontal lines. For clarity, the more stringent Reliability Value (the higher value) is henceforth described herein as the Design Reliability, RDₘₐₓ, while the less conservative value, used to establish the Margin, is henceforth described herein as the Margin Reliability, RMₘᵢₙ.

To develop an ESAL Margin for a specific road, a forensic investigation is preferably done. The Margin for a paved road is developed based on the Last Major Treatment and the DL_{E} for that treatment. The developer's damage is then considered within the context of this time period only, because to go further into the past than this would be unmanageable and unnecessary. This is done through a forensic investigation of the in situ road and then a reverse engineering process. The forensic investigation determines the Structural Number built at the time of the Last Major Treatment. This SN, together with the other variables of the AASHTO pavement design equation, yields the lifetime ESALs. The annual ESALs, determined by the traffic count, then yields the years of life that SN will have provided beginning at the time of the Last Major Treatment. However, the lifetime design ESAL calculation is done twice, one time each for the minimum and maximum selected Reliability Factors, as explained above. This yields the lifetime ESAL Capacity Margin for the road from the time the Last Major Treatment was built. FIG. 2 illustrates the concept of the ESAL Capacity Margin. The steps to generate FIG. 2 are discussed below.

### Forensic Investigation

In some embodiments, one or more steps of the following forensic investigation procedures is performed. A forensic investigation of the proposed haul route is conducted to determine the in situ Structural Number of the road based on the layer types, thicknesses, and laboratory test results. The forensic investigation preferably includes digging four test pits per mile. The pits are preferably dug from the pavement edge to approximately ⅔ the width of the lane. The pits should be deep enough to penetrate to the natural sub-grade. They are preferably selected to represent a variation in the road conditions. A falling weight deflectometer may be used, if desired, to identify the distribution of deflections along the road. If a deflectometer is used, a deflection profile of the road is preferably plotted using data from the sensor directly under the load, which is influenced by all of the road bed layers. Representative test pit locations are selected from the deflection profile that meet a predetermined criterion, such as, for example, the 85th percentile or another reasonable percentile, of the deflection distribution.

Preferably, a cross section sketch of the test pits is drawn, complete with layer dimensions and widths of each gravel layer. The layer thicknesses are measured and recorded at the outer wheel path, middle of the lane, and inner wheel path region of each test pit. Samples are removed of every unique layer of aggregate and the sub-grade material from the test pits. The location of where the samples were taken is marked on the test pit diagrams.

Each layer of asphalt concrete of the test pits is classified as dense graded hot mix, dense graded cold mix, open graded cold mix, or bituminous surface treatment and the asphalt layer thicknesses are identified. The asphalt layer thicknesses and material classification are measured and recorded on the cross section diagram at the outer wheel path, inner wheel path, and middle of the lane.

Four-inch or six-inch cores are preferably taken in the amount of six per centerline mile, with two in the center of the roadway and two each in the outer wheel paths for thin and thick asphalt pavements. Coring is typically not necessary for surface treatment roads. In the case of thin and thick asphalt pavements, the four test pits yield the equivalent of three ‘cores’ for each test pit, including one each from the outer wheel path, inner wheel path, and middle of the lane. Including the asphalt information from the test pits and the 6 additional cores taken per mile, the equivalent of 18 core samples are preferably taken per mile.

### Laboratory Testing and Evaluation

In some embodiments, one or more steps of the following laboratory testing and evaluation procedures is performed. Laboratory tests are performed on all unique gravel specimens removed from the layers of the test pits. Sieve Analysis and Atterberg Limits tests are performed on all specimens. From this information, the materials may be classified according to the Unified Soils Classification System. Then based on the Unified Soils Classification System, the California Bearing Ratio (CBR) of the granular base materials and the Sub-grade Resilient Modulus may be estimated. Alternatively, CBR tests may be done on each gravel material and a tri-axial test may be done on the sub-grade to determine its Resilient Modulus. The CBR values are used to estimate a-coefficients of the granular base materials using the applicable tables in the AASHTO Guide for the Design of Pavement Structures. If soil cement is encountered, engineering judgment should be used to first determine its cohesiveness and condition. If the material has apparent high strength, cores should be removed and tested in the laboratory for unconfined compressive strength and the a-coefficient may be estimated from the test results. Alternatively, if the material is no longer bound and is loose and unconfined, it may be sampled and tested as an aggregate. Similarly, if asphalt emulsion stabilized material is encountered, four inch cores may be removed, if the material is cohesive, and tested for Marshall Stability in the laboratory. This may then be used to estimate a-coefficients. If the material is not cohesive, it may be tested and evaluated like an aggregate.

Each of the six cores is examined to determine the asphalt material types. The thickness and type of material of each layer of the core are identified. The materials are categorized as open graded cold mix, dense graded cold mix, dense graded hot mix, or a surface treatment layer. Estimated a-coefficients are assigned as follows for the layers of the 6 cores and the 12 ‘cores’ from the test pits:

Open Graded Cold Mix—0.15 to 0.33.

Dense Graded Cold Mix—0.15 to 0.38

Dense Graded Hot Mix—0.15 to 0.42

Bituminous Surface Treatment—0.15 to 0.40

For thin and thick asphalt pavements, the uppermost thick overlay should be considered as the Last Major Treatment. This layer is assigned an a-coefficient as if it were brand new material. For hot mix, the value 0.44 is preferably used. For open graded cold mix, the value 0.33 is preferably used. For dense graded cold mix, the value 0.38 is preferably used. For surface treatment pavements, the value 0.30 is preferably used. Engineering judgment is used based on an evaluation of the current surface distresses and anecdotal information from the highway agency about pavement conditions of the lower asphalt layers when they were overlaid to select appropriate a-coefficients.

Alternatively, 4-inch or 6-inch cores may be cut into 2.5-inch high specimens and tested in a laboratory for Marshall Stability. A particular core may have to be cut into several specimens and each specimen tested separately. The a-coefficients may then be estimated from the results of the tests, using the relevant asphalt a-coefficient tables in the AASHTO Guide for the Design of Pavement Structures. If this is the case, then each specimen tested should represent a ‘layer’ in the equation below to calculate the SN for the core. The Structural Number of each core of the 6 actual cores and the 12 test pit ‘cores’ is calculated in accordance with an SN equation (equation 2):

SNₑₒᵣₑ=a₁d₁t₁+a₂d₁t₂+a₃d₃t₃aᵢdᵢtᵢ (2)

where a=asphalt layer co-efficient, d=drainage co-efficient (for asphalt concrete use 1.0), and t=asphalt layer thickness.

From the 18 core Structural Numbers, the inner wheel path, outer wheel path, and middle lane structural numbers are separated into three groups of six data points for each group. The 80th percentile IWP Core Structural Number (SN_{IWPC}), OWP Core Structural Number (SN_{OWPC}), and ML Structural Number (SN_{MLC}) are determined. These values are used as the representative Structural Numbers for the Inner Wheel Path, Outer Wheel Path, and Middle Lane values for the asphalt pavement of all four test pits.

### Determination the In Situ Structural Number (SN_{LMT})

In some embodiments, one or more of the following steps is performed to determine an in situ Structural Number. Cross Section Diagrams are prepared for each Test Pit and on these diagrams the a-coefficients are recorded for each identified layer above the sub-grade. The Structural Number of the test pit is calculated in three locations, including the center of the lane, the inner wheel path region of the lane, and the outer wheel path region of the lane. The layers of each calculation include the gravel and asphalt layers. This yields 12 representative structural numbers for the mile of roadway under consideration, four each for the inner wheel path, outer wheel path, and middle of the lane. For the test pit outer wheel path:

Test Pit 1 Outer Wheel Path=SN_{OWP}=SN_{OWPC}+SN_{G1}+SN_{G1}+SN_{G3} (3)

where SN_{OWPC}=Structural Number of the Outer wheel path core and SN_{Gi}=aᵢdᵢtᵢ,

where aᵢ=the a-coefficient of a gravel layer, dᵢ=the drainage co-efficient of the gravel layer, and tᵢ=thickness of a gravel layer.

The calculations are repeated for the Inner Wheel Path and the Middle of the Lane:

Test Pit 1 Inner Wheel Path SN_{IWP}=SN_{IWPC}+SN_{G1}+SN_{G1}+SN_{G3} (4)

Test Pit 1 Middle Lane SN_{ML}=SN_{MLC}+SN_{G1}+SN_{G1}+SN_{G3} (5)

The calculations are repeated for each of Test Pits 2, 3, and 4. There are then four SN values for each of the Inner Wheel Path, Outer Wheel Path, and Middle Lane regions of the road (one from each Test Pit). The 80th percentile Structural Number is determined for the IWP, OWP and ML. The lowest of these three values is selected to represent the overall in situ Structural Number of the Last Major Treatment for the road, SN_{LMT}.

### Year of Last Major Treatment

The year of the Last Major Treatment is preferably determined by the following procedure. The cores and test pits are examined to determine what the last major treatment was at that time and information is obtained from the highway agency about when it was done. If the road is a thick asphalt pavement, the top overlay of the core is the Last Major Treatment and the year of application is the time of the last major treatment. If the pavement is a thin asphalt pavement (between 1 and 3 inches thick), including a build up of surface treatments, then the period of years of the build up must be estimated. The year of the last major treatment is the year that is the mid point of the period of years over which the built up layers of the top 3-inches of the core accumulated. If the pavement is a surface treatment of less than 1-inch in thickness, the same applies as for a thin asphalt pavement, namely the year that is the mid point of the period of years over which the chip seals were placed is determined

### Determination of the Present Baseline ESALs Per Year

The present baseline ESALs per year is preferably determined by the following procedure. The Annual Daily Traffic (ADT) and the make up of the traffic stream of the ADT are determined by conducting the traffic study with counters that have the capability of counting and sorting the vehicles according to the 13 standard FHWA vehicle classes. The ADT is determined by doing a 3-day count in the middle of a typical business week. A reasonable assumption is made for the number of loaded versus unloaded trips for the truck class counts. Gross Vehicle Weights are assigned to each vehicle class and the weight on each axle of each vehicle class for the loaded and unloaded conditions. Using the Load Equivalency Factor tables in the AASHTO Guide for the Design of Pavement Structures, the axle weights of each vehicle are converted to ESALs, and then the total number of ESALs per vehicle are determined for each of the 13 vehicle classes, including loaded and unloaded for the truck classes. The number of ESALs per vehicle is multiplied by the number of trips of the vehicles in that class per day, for both the loaded and unloaded conditions, to determine the ESALs per day for each vehicle class. The ESALs per day are summed for all of the 13 vehicle classes to obtain the total ESALs per day. The result is multiplied by 365 to obtain the ESALs per year.

### Base Line ESALs Per Year (BL_{E}) for the Year of the Last Major Treatment

The current Baseline ESALs per year are converted to ESALs per year in the year of the Last Major Treatment. The financial accounting formula for future value of a present worth is preferably used, because it determines the future value of a present value, or vice versa, using an inflation rate and a time period. In this case, ESALs is substituted for dollars and traffic growth rate, during the period of time of the LMT, to account for inflation rate. The number of years since the LMT was done, as determined above, until the present time is used as the ‘n’ value in the equation. Equation 6 is solved for P:

F=P(1+i)ⁿ (6)

where P=Baseline ESALs/year at time of LMT, F=Current Baseline ESALs/year, i=traffic growth rate, and n=years since LMT.

### Calculation of the E_{L} of the Last Major Treatment

Using the AASHTO pavement design equation, the design ESALs (E_{LRMmin} and E_{LRDmax}) for the LMT are calculated using a minimum and maximum Reliability factor (RMₘᵢₙ and RDₘₐₓ). The nomograph published in the AASHTO Guide for the Design of Pavement Structures may be used or alternatively computer programs are available for solving the AASHTO pavement design equation. The other inputs for the AASHTO equation are the same for the two calculations using RMₘᵢₙ and RDₘₐₓ. These inputs include the SN_{LMT}, standard deviation, Initial Serviceability, Terminal Serviceability, and the sub-grade resilient modulus (M_{R}). M_{R} may be a seasonally adjusted value in accordance with the AASHTO Guide for the Design of Pavement Structures. RMₘᵢₙ and RDₘₐₓ are preferably selected from the following recommended ranges:
1. Low volume residential streets and roads—65% to 80%
2. Local collectors—75% to 90%, and for
3. Local arterials—85% and higher.
Margin is the difference of E_{LRmin} and E_{LRmax} as shown in equation 7:

Margin=E_{LRMmax}−E_{LRDmin} (7)

### Calculation of a DL_{E} of an LMT

An NPER financial accounting formula (see equation 8) is preferably used to determine the Expected Design Life (DL_{ERMmin} and DL_{ERDmax}) for the road for both the E_{LRMmin} and E_{LRDmax} values determined for the minimum and maximum Reliability factors. BL_{E} is used as the annual Payment input into the equation, E_{LRMmin} and E_{LRDmax} are used as the Present Values, and 0 is used as the Future Value for the two calculations for RMₘᵢₙ and RDₘₐₓ. An appropriate traffic growth factor is selected to be used as the ‘rate’ in the equation. Solution of this equation yields the number of years for BL_{E} to accumulate to E_{LRMmin} and E_{LRDmax} at the selected traffic growth rate. This number of years becomes the Design life (DL_{ERMmin} and DL_{ERDmax}) for the minimum and maximum Reliability factors.

$$N = \frac{100 \sqrt{\frac{Px ( 1 + r ) + ( - \frac{1}{r} xFv )}{Pvxr + Px ( 1 + r )}}}{\sqrt{1 + r}} \qquad ( 8 )$$

where N=DL_{ERMmin} or DL_{ERDmax}, r=traffic growth rate, P=BL_{E} (at time of last major treatment), Pv=E_{LRMmin} or E_{LRDmax}, and Fv=0.

### Construction of a Fishnet ESAL Margin Plot (See FIG. 2)

A Fishnet ESAL Margin Plot is preferably constructed by the following procedure. The ESAL depreciation curves of E_{LRMmin} and E_{LRDmax} are plotted. The curves are plotted on a y-axis, where the units are ESALs per year and the x-axis is years. The y-coordinate for each x value is obtained by dividing EL_{RMmin} or EL_{RDmax} by x for each of the two curves for the two reliability factors RMₘᵢₙ and RDₘₐₓ. The baseline traffic ESALs per year is plotted as shown on FIG. 2 (the lower horizontal line of FIG. 2). The baseline traffic plus Margin line (the upper horizontal line of FIG. 2) and the corresponding design life vertical lines are also plotted.

FIG. 2 is useful for illustrating the concept of Margin without the complication of the affects of the time of year on the sub-grade strength and the variation in damage of developers depending on the time of year they choose to traffic the road. However, sub-grade seasonal variation of strength is an important issue, because if the fishnet model incorporates the affect of it on heavy road user traffic, the heavy road user traffic may be managed more effectively. For example, a particular development project would do less damage if is done in July compared to April and may not have to be regulated at all. Therefore, while FIG. 2 illustrates the concept of Margin with respect to the variable of Reliability, it does not include the variable of sub-grade strength and its impact on traffic damage. The model is preferably expanded to express Margin in terms of the Damage Coefficient as a function of sub-grade conditions.

### Damage Margin Analysis

Damage Margin Analysis preferably follows the following procedures but is somewhat different for gravel roads versus paved roads because of different definitions of failure for gravel roads.

For thin and thick bituminous pavements, terminal failure is preferably defined by the pavement design equation in terms of ΔPSI. For gravel roads, failure is preferably defined by acceptable rut depth or ΔPSI using two different equations. The equation that yields the lower ESAL capacity is preferably selected to govern for a gravel road.

Surface treatments are preferably analyzed by a hybrid application of both the paved road design equations and the gravel roads design equations. The lowest ESAL capacity defined by these two approaches is then be used for thin surface treatment roads.

### Paved Roads Damage Margin Analysis for Thin and Thick Bituminous Pavements

The first steps of a Damage Margin Analysis are similar to those presented above on the ESAL Margin. However, with the Damage Analysis, the concept of Margin is expanded to include the effect of seasonal variation in sub-grade for the months that the declared heavy road user actually proposes to put his traffic on the road. The basic steps presented above are summarized again here but then the results are used in the damage margin analysis:
1. Conduct forensic investigation
2. Perform laboratory testing
3. Conduct Traffic Study
4. Calculate current Baseline Annual ESALs
5. Determine the Last Major Treatment
6. Calculate the SN_{LMT}
7. Determine sub-grade Resilient Modulus
8. Determine the year of the Last Major Treatment
9. Select a traffic growth rate for the period of time of the Last Major Treatment
10. Convert current Baseline Annual ESALs to Baseline Annual ESALs in the year of the Last Major Treatment
11. Select RMₘᵢₙ and RDₘₐₓ.
12. Use the AASHTO Design Equation to calculate E_{LRMmin} and E_{LRDmax}
13. Calculate DL_{ERMmin} and DL_{ERDmax} using the selected traffic growth rate and the Annual Baseline ESALs in the year of the Last Major Treatment.

Damage is preferably expressed as a coefficient with a maximum value of 1.0 (100% damage). In each month of the year the sub-grade strength varies due to weather conditions. In the winter the sub-grade is frozen and very strong. In late winter and early spring the ground is saturated with water and the sub-grade is at its weakest. In late spring sub-grade strength increases as ground water dissipates. In the summer the ground dries and the sub-grade strength increases to its summer peak strength. In the fall as ground water increases again, the strength goes down, until it freezes for the winter. To determine the damage analysis, each month is considered individually, over the design life of the road. An AASHTO pavement design calculation is performed to determine E_{LRMmin} and E_{LRDmax} for the in situ SN_{LMT} for the given sub-grade strength for the month. This is done for each month. Then, the actual baseline ESALs for each month are summed and divided by E_{LRMmin} and E_{LRDmax} in order to be expressed as a percent of E_{LRMmin} and E_{LRDmax}. The fractions for each month multiplied by DL_{E} are then added up for both E_{LRMmin} and E_{LRDmax}. The total damages for all 12 months of the year, for the number of years of the Design life, must not exceed 1.0 (or 100%).

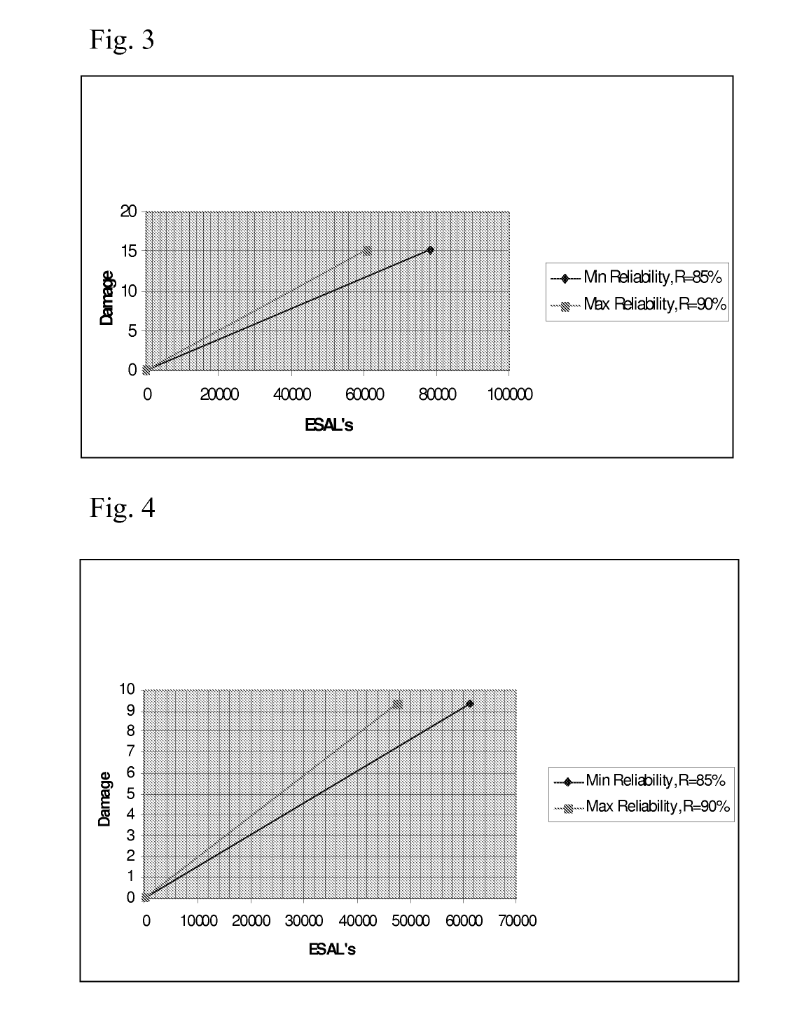

In actuality, damages may reach 1.0 in only one month of the year, over the Design Life, for example the traffic in April over all the Aprils of the Design Life, if there is enough traffic in that month. This means that E_{LRMmin} or E_{LRDmax} are consumed in that month alone and there is no more remaining ESAL capacity to be consumed in any other month. Similarly, if development traffic is high in several months, the ESAL capacity of SN_{LMT} may be consumed by the cumulative effect of the traffic in those months over the Design Life. This is an advantage of using a Damage analysis. If the model is reduced to a one year analysis, then Declared Heavy Road User Traffic may be managed on a month by month basis to avoid the potential for excessive damage and regulation. For example, if a declared heavy user agrees to shift his traffic to a dry month from a wet month, damages are minimized and regulation is avoided for the given analysis year. The Design Life damage analysis is illustrated in FIG. 3 through the use of a Design Lifetime Damage Chart. This chart plots a damage coefficient on the y-axis versus ESALs on the x-axis. The following Table 1 illustrates a method by which the Lifetime Damage Chart is prepared. In this embodiment, the following information is used to create the damage chart:

### Data for a Proposed Haul Route

1. The in situ structural number of the road is SN_{LMT}=2.5
2. The following input variables for the AASHTO Design Equation are selected:
   a. Standard Deviation=0.45
   b. Margin Reliability=85%
   c. Design Reliability=95%
   d. Initial Serviceability Index=4.2
   e. Terminal Serviceability Index=2.0
3. Traffic Growth Rate=Assume 0% for simplicity
4. Sub-grade Resilient Modulus, M_{R}=5000 psi. Note: This value must be carefully assumed based on lab test results and engineering judgment. It will used to seed Table 1 for the first iteration of calculations in the table.
5. The Baseline ESALs per year of the road in the year of the Last Major Treatment is determined to be 5,000 (from the ADT, conversion of ADT to ESALs and then discounting the present ESALs/year by a traffic growth factor to the ESALs per year at the time of the LMT). In this case traffic growth is assumed to be 0% therefore the Baseline ESALs per year at the time of the LMT is the same as the current Baseline ESALs per year, which is 5,000.

### First Iteration of the Damage Analysis Procedure

1. Calculate the design lifetime E_{LRMmin} and E_{LRDmax} for RMₘᵢₙ and RDₘₐₓ using the assumed sub-grade Resilient Modulus of 5000 psi. Use the AASHTO pavement design equation (the AASHTO published Nomogram or by the use of a selected AASHTO design software program) to perform these calculations. The results are listed below:
   a. The E_{LRMmin} (RMₘᵢₙ of 85%) is 78,300 which yields a design life of 15.66 years (Traffic growth rate is assumed to be 0%).
   b. The E_{LRDmax} (RDₘₐₓ of 90%) is 60,800 which yields a design life of 12.16 years (Traffic growth rate is assumed to be 0%).
2. Set up Table 1:
   a. Column 1—Choose values for M_{R} Based on engineering judgment, laboratory test results of the sub-grade material, and with the help of Table 2 and Table 3 published in Appendix A for the Design of Gravel Roads, in the AASHTO Guide for the Design of Pavement Structures. These tables provide recommended sub-grade Resilient Modulus values for various regions of the country and for various qualities of sub-grade taking into account weather conditions.
   b. Column 2—This is the total ESALs that occurs in each month over the lifetime of the road for RMₘᵢₙ. It is calculated by dividing the design life time ESALs for RMₘᵢₙ by 12. This assumes an even distribution of baseline ESALs per month throughout the year.
   c. Column 3—This is the total ESALs that occurs in each month over the lifetime of the road for RDₘₐₓ. It is calculated by dividing the design life time ESALs for RDₘₐₓ by 12. This assumes an even distribution of baseline ESALs per month throughout the year.
   d. Column 4—This is the total lifetime ESALs the SN could support if the sub-grade modulus remained at the assigned value for the month (indicated in Column 1) with RMₘᵢₙ. It is determined by using the assigned sub-grade resilient modulus for the month in the AASHTO design equation.
   e. Column 5—This is the total ESALs the SN could support if the sub-grade modulus remained at the assigned value for the month (indicated in Column 1) with RDₘₐₓ. It is determined by using the assigned sub-grade resilient modulus for the month in the AASHTO design equation.
   f. Column 6—This is the damage calculation for RMₘᵢₙ. It is calculated by dividing the value in Column 2 by the value in Column 4
   g. Column 7—This is the damage calculation for RDₘₐₓ. It is calculated by dividing the value in Column 3 by the value in Column 5
3. Create a chart as in FIG. 3. FIG. 3 plots the Design Life Damage line for E_{LRMmin} and E_{LRDmax} using the assumed M_{R} of 5000 psi. Damage is plotted on the y-axis and ESALs are plotted on the x-axis. The monthly damage coefficients are essentially the same for the E_{LRMmin} and E_{LRDmax} in columns 6 and 7. This is because both columns were calculated with the same M_{R} monthly distribution. However, the design life for E_{LRMmin} and E_{LRDmax} are different because of the different Reliability values. The sum of the damages (which is 1.25 for each of columns 6 and 7) is multiplied by 12.16, the design life of the RDₘₐₓ of 90% (the more conservative design life), which yields a life time damage coefficient of 15.2 for both E_{LRMmin} and E_{LRDmax}. This is done for convenience so that when a one year period is considered, the 100% damage coefficient is 1.0 (after iterations) which is further explained below and illustrated.

### Perform Successive Iterations of the Damage Analysis Procedure

The calculations are preferably not complete with the first iteration described above and a second iteration is preferably performed. A discrepancy is seen by comparing the Design Life for E_{LRMmin} and E_{LRDmax} to the sum total damage values. In theory if the annual damage coefficient is desired to be 1.0, then the Life Time damage coefficient is 1.0 multiplied by the Design Life. In this case it should be 1.0 times the more conservative design life of 12.16 (for RDₘₐₓ=90%). However, 12.16 does not equal the actual Life Time Damage value of 15.2, indicated as the sum total damage in columns 6 and 7. Therefore an iterative process is preferably done by varying M_{R} in the AASHTO design equation until EL_{RMmin} and EL_{RDmax} yield Lifetime Design ESAL values that return sum total annual Life Time Damage values in columns 6 and 7 equal to the actual Design Life of EL_{RDmax}, where EL_{RDmax} has been selected as the conservative design criteria and EL_{RMmin} is the criteria that will create the Damage Margin.

Table 2 shows the final results of this iterative process where the design life for E_{LRDmax} (which is 9.52) is nearly the same as the sum total Lifetime Damage value for E_{LRDmax}. Again the total damage of column 7 is multiplied by the design life for E_{LRDmax} (which is 9.52) to obtain the total Lifetime Damage value of 9.35. Since 9.35 is nearly equal to 9.52, the iterative process was concluded. At this point the M_{R} value used in the AASHTO equation represents the monthly distribution of M_{R} values, and the conservative design life of RDₘₐₓ matches the total Lifetime Damage Factor, with the annual allowable damage being 1.0, and thus 9.35 is approximately equal to 9.52. Once again, the annual Lifetime Damage value for EL_{RMmin} and EL_{RDmax} are essentially the same value of 9.35 due to the same M_{R} distribution.

TABLE 1
Lifetime Design ESALs Table Before Iterations

| | Column 1 | Column 2 | Column 3 | Column 4 | Column 5 | Column 6 | Column 7 |
|---|---|---|---|---|---|---|---|
| ESAL's/year at time of | 5000 | | | | | | |
| Last Major Treatment | | | | | | | |
| Design life ESALS, 85% R | | 78.300 | | Design life ESALS, 90% R | | 60.800 | |
| Design Life, 85% R | | 15.66 | | Design Life, 90% R | | 12.16 | |
| | | Cumulative | Cumulative | Minimum | Maximum | Minimum | Maximum |
| | | Lifetime | Lifetime | Lifetime | Lifetime | Lifetime | Lifetime |
| | | ESAL's | ESAL's | ESAL's | ESAL's | ESAL's | ESAL's |
| | Resilent | In the month | In the month | (Min Reliability, | (Max Reliability | Damage | Damage |
| Month | Modulus | Min Reliability | Max Reliability | 85%) | 90%) | (Min Reliability) | (Max Reliability) |
| January | 50,000 | 6525 | 5067 | 16363500 | 12,694,800 | 0.000398753 | 0.000399114 |
| February | 50,000 | 6525 | 5067 | 16363500 | 12,694,800 | 0.000398753 | 0.000399114 |
| March | 20,000 | 6525 | 5067 | 1952800 | 1,515,000 | 0.003341356 | 0.003344334 |
| April | 3000 | 6525 | 5067 | 23900 | 18,600 | 0.273012552 | 0.272401434 |
| May | 5000 | 6525 | 5067 | 78300 | 60,800 | 0.083333333 | 0.083333333 |
| June | 5000 | 6525 | 5067 | 78300 | 60,800 | 0.083333333 | 0.083333333 |
| July | 5000 | 6525 | 5067 | 78300 | 60,800 | 0.083333333 | 0.083333333 |
| August | 5000 | 6525 | 5067 | 78300 | 60,800 | 0.083333333 | 0.083333333 |
| September | 5000 | 6525 | 5067 | 78300 | 60,800 | 0.083333333 | 0.083333333 |
| October | 3000 | 6525 | 5067 | 23900 | 18,600 | 0.273012552 | 0.272401434 |
| November | 3000 | 6525 | 5067 | 23900 | 18,600 | 0.273012552 | 0.272401434 |
| December | 10000 | 6525 | 5067 | 391100 | 303,400 | 0.016683713 | 0.016699626 |
| | | 78300 | 60800 | | | 15.27936709 | 15.25731197 |

### Creation of a Final Lifetime Damage Versus ESAL Plot

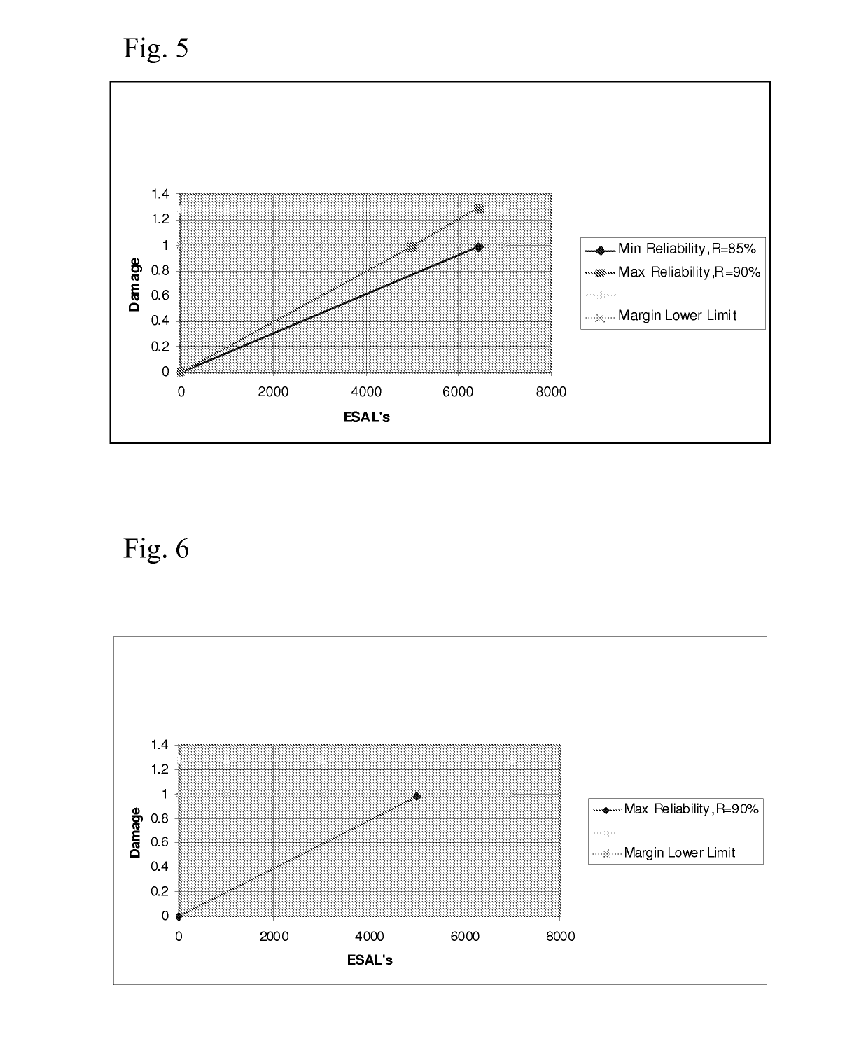

FIG. 4 illustrates the plot of the final iteration. FIG. 5 illustrates the construction of the Lifetime Margin. The Lifetime Margin is established by extending the 90% RDₘₐₓ line to the point where it intersects a vertical line that passes through the intersection of the 85% RMₘᵢₙ line with the 9.52 horizontal Damage line and drops down to the EL_{RMmin} value of 61,300 ESALs. The 9.52 Damage line represents the total consumption of all allowable damage such that each year of the 9.52 lifetime consumes a damage factor of 1.0. The 90% RDₘₐₓ line yields a total Damage of 12.18 when it intersects the vertical ESAL line of 61,300. Therefore the total lifetime damage margin is 12.18 minus 9.52 or 2.60. The Annual Allowable Damage Margin is 2.6 divided by 9.52, or 0.273.

TABLE 2
Lifetime Design ESALs Table After Iterations

| | Column 1 | Column 2 | Column 3 | Column 4 | Column 5 | Column 6 | Column 7 |
|---|---|---|---|---|---|---|---|
| ESAl's/year at time of | | | 5000 | | | | |
| Last Major Treatment | | | | | | | |
| Design life ESALS, 85% R | | 61.300 | | Design life ESALS, 90% R | | 47.600 | |
| Design Life, 85% R | | 12.26 | | Design Life, 90% R | | 9.52 | |
| | | Cumulative | Cumulative | Minimum | Maximum | Minimum | Maximum |
| | | Lifetime | Lifetime | Lifetime | Lifetime | Lifetime | Lifetime |
| | | ESAL's | ESAL's | ESAL's | ESAL's | ESAL's | ESAL's |
| | Resilent | In the month | In the month | (Min Reliability, | (Max Reliability, | Damage | Damage |
| Month | Modulus | Min Reliability | Max Reliability | 85%) | 90%) | (Min Reliability) | (Max Reliability) |
| January | 50,000 | 5108 | 3967 | 16363500 | 12,694,800 | 0.000312179 | 0.000312464 |
| February | 50,000 | 5108 | 3967 | 16363500 | 12,694,800 | 0.000312179 | 0.000312464 |
| March | 20,000 | 5108 | 3967 | 1952800 | 1,515,000 | 0.002315902 | 0.002618262 |
| April | 3000 | 5108 | 3967 | 23900 | 18,600 | 0.213737796 | 0.213261649 |
| May | 5000 | 5108 | 3967 | 78300 | 60,800 | 0.065240528 | 0.065241228 |
| June | 5000 | 5108 | 3967 | 78300 | 60,800 | 0.065240528 | 0.065241228 |
| July | 5000 | 5108 | 3967 | 78300 | 60,800 | 0.065240528 | 0.065241228 |
| August | 5000 | 5108 | 3967 | 78300 | 60,800 | 0.065240528 | 0.065241228 |
| September | 5000 | 5108 | 3967 | 78300 | 60,800 | 0.065240528 | 0.065241228 |
| October | 3000 | 5108 | 3967 | 23900 | 18,600 | 0.213737796 | 0.213261649 |
| November | 3000 | 5108 | 3967 | 23900 | 18,600 | 0.213737796 | 0.213261649 |
| December | 10000 | 5108 | 3967 | 391100 | 303,400 | 0.013061451 | 0.01307405 |
| | | 61300 | 47600 | | | 9.364992867 | 9.351575262 |

FIG. 5 shows a chart that is used for regulation purposes. To use the chart the RMₘᵢₙ line is preferably removed for clarity, and the chart is therefore used as it appears in FIG. 6.

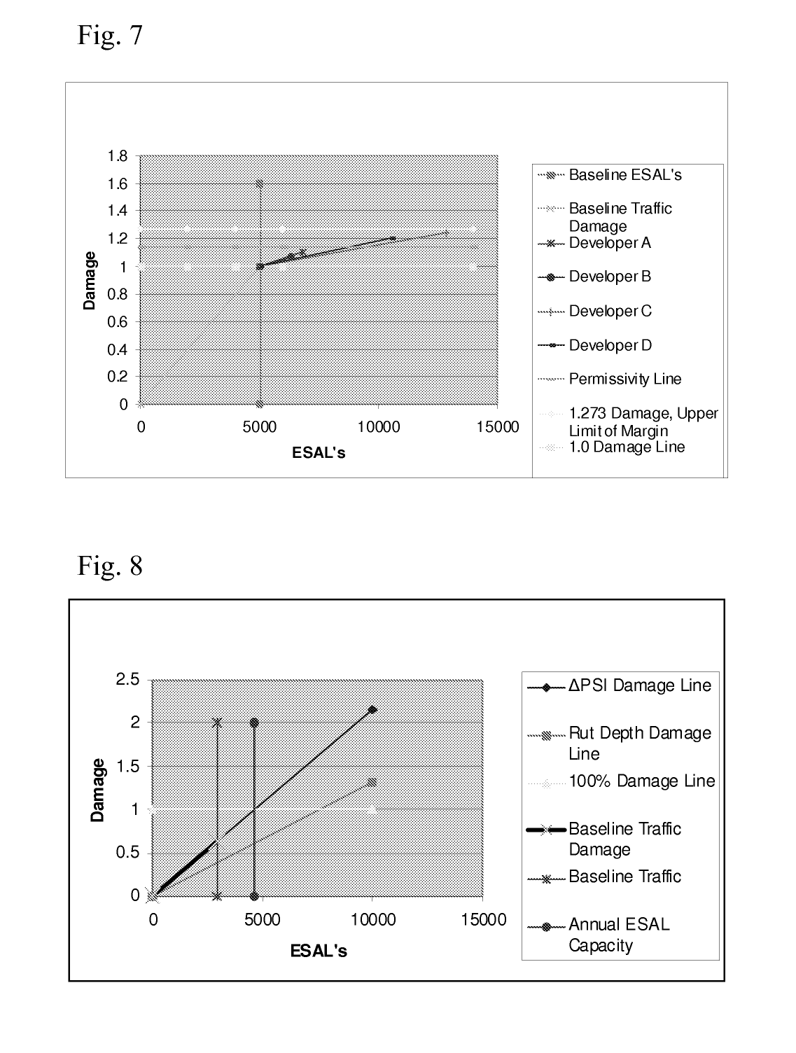

FIG. 6 represents a Fishnet Damage Chart for regulation purposes. Heavy Road User Damage lines are then plotted on the chart. The road user damages are added into separate columns of Table 1 and Table 2 above. Multiple columns may be added if desired for several developers. The heavy road user traffic damage is calculated in the same way as the baseline traffic, as a percent, by month. However heavy road user damage need not be calculated as a percent E_{LRMmin} and E_{LRDmax}, but may rather be calculated only using E_{LRDmax}, because that is the conservative value used for the calculated Design Life for the Baseline traffic, and E_{LRMmin} was only used to establish the upper limit of the Margin. The Heavy Road User cumulative damage, for all months of his operation, is calculated then in the same way as for the baseline traffic in Table 1 and Table 2 and totaled and plotted versus his total ESALs for the year. However, the Heavy Road User damage line is plotted such that it begins at the end point of the base line traffic. Table 3 shows calculation results for Heavy Road User Damages. FIG. 7 indicates the Fishnet Damage Chart with Damage lines for four developers.

TABLE 3
Regulated Heavy Road User Damages

| | | Devel- | Devel- | Devel- | Devel- | | | | | |
|---|---|---|---|---|---|---|---|---|---|---|
| | | oper A | oper B | oper C | oper D | Maximum | | | | |
| | Re- | Monthly | Monthly | Monthly | Monthly | Lifetime | Developer | Developer | Developer | Developer |
| | silent | ESAL | ESAL | ESAL | ESAL | ESAL's | A Amount | B Amount | C Amount | D Amount |
| | Mo- | Disti- | Disti- | Disti- | Disti- | Rmax = | ESAL | ESAL | ESAL | ESAL |
| Month | dulus | bution | bution | bution | bution | 90% | Damage | Damage | Damage | Damage |
| January | 50,000 | | | | | 12,834,800 | 0 | 0 | 0 | 0 |
| February | 50,000 | | | | | 12,694,800 | 0 | 0 | 0 | 0 |
| March | 20,000 | | | | | 1,515,000 | 0 | 0 | 0 | 0 |
| April | 3000 | 1550 | 1300 | 2000 | 3000 | 18,600 | 0.099 | 0.069892473 | 0.107526882 | 0.161290323 |
| May | 5000 | | | 800 | 2500 | 60,800 | 0 | 0 | 0.013157895 | 0.041118421 |
| June | 5000 | | | 1000 | | 60,800 | 0 | 0 | 0.016447368 | 0 |
| July | 5000 | | | 1000 | | 60,800 | 0 | 0 | 0.016447368 | 0 |
| August | 5000 | | | 1000 | | 60,800 | 0 | 0 | 0.016447368 | 0 |
| September | 5000 | | | 1000 | | 60,800 | 0 | 0 | 0.016447368 | 0 |
| October | 3000 | | | 1000 | | 18,800 | 0 | 0 | 0.053763441 | 0 |
| November | 3000 | | | | | 18,800 | 0 | 0 | 0 | 0 |
| December | 10000 | | | | | 303,400 | 0 | 0 | 0 | 0 |

| | | | | | | | | |
|---|---|---|---|---|---|---|---|---|
| Totals | 1550 | 1300 | 7800 | 5500 | 0.099482 | 0.0699 | 0.2402 | 0.2024 |

### Determining Damage Liability Cost Shares

FIG. 7 includes an additional line, the Permissivity Factor Line. As explained above the Permissivity Factor is set by assuming how many declared heavy road users might use the road in a given year. In this example, it was estimated that two developers are expected such that the Permissivity factor is 0.5 (when, in fact there are four declared heavy road users). The annual allowable margin is thus multiplied by the Permissivity factor to establish the actual fishnet allowable range for any single declared heavy road user. The dotted line labeled 1.136 is the actual threshold below which a heavy road user line will have to fall to not be regulated.

The region below the 1.136 line is referred to herein as the Permissive Damage Margin. The region between the 1.273 and 1.136 lines is referred to herein as the Regulated Damage Margin. If the Permissivity Factor is set to 1 or greater than 1, then there is no regulated margin, but only a Permissive Damage Margin. The Permissivity Factor is set to less than 1.0 if there is more than one declared heavy road user expected to use the road in a given RUA analysis period of 1-year. If it is expected that heavy road users may use the road only once in some period of years, then the Permissivity Factor is set to greater than 1.0.

Permissive Margin is defined herein as the allowable damage that a declared heavy road user must be equal to or less than in order not to be regulated. If there are multiple developers who fall below the 1.136 line, for example, Developer A and Developer B, any damage they cumulatively cause that exceeds 0.136 becomes the liability of the Municipality because the municipality underestimated the projected number and magnitude of declared heavy road users and set the permissivity factor too high to ‘catch’ the declared heavy users. This damage exceeding the Permissive Margin is referred to herein as the Excess Permissible Damage. Therefore it is incumbent upon the Municipality to carefully select the Permissivity factor.

Regulated Margin is available to offset the damages of those Developers who fall between the 1.136 line and the 1.273 line, in this example. In this example it would be Developers C and D. The Regulated Margin may be deducted proportionally (i.e. shared proportionally as a credit) from the damage caused by C and D that exceeds the 1.273 line. The portion of the Regulated Margin credited to a Regulated Heavy Road User is referred to herein as the Regulated Damage Offset Credit. The damages of C and D are summed and the amount that this sum exceeds the 1.273 line is considered regulated damages. The portion of the regulated damage done by a single Regulated Heavy Road User is their Regulated Total Damage Liability. It is the amount of regulated damages caused by C and D that is used in the calculation to determine their proportion of payment for damages. The calculations for proportioning liability among multiple users, for the example shown in FIG. 7, appear in Tables 4 and 5.

Table 4 presents a summary of permissive margin and net regulated damages. The Permissive Damages in this case includes the damage of 1.0 done for the year by the municipality. This is important, because the Regulated Total Damage Liability of a Regulated Heavy Road User is preferably expressed as the total of all damages in order to be fair to the developers. This insures the developers do not pay for the damages done by the municipal base line traffic. In this example there are four developers, which would likely be unusual. However, the total damages of the four developers are relatively minor In the case of large developers, such as wind farms or gas drilling, the developer damage lines could be as much or more than the municipal baseline annual traffic.

TABLE 4
Permissive Margin and Net Regulated Damages Summary

| | | | Permissive | Permissive Damage |
|---|---|---|---|---|
| | | Permissive | Damage Excess | Offset Credit |
| | Permissive | Damage | (of declared | (available for credit |
| Developer | Damage | Margin | heavy users) | to regulated users) |
| A | 0.070 | | | |
| B | 0.110 | | | |
| Munici- | 1.000 | | | |
| pality | | | | |
| Total | 1.180 | 0.136 | 0.044 | 0.000 |

| | | Permissive | Regulated | Net |
|---|---|---|---|---|
| | Total Damage | Damage Off | Damage | Regulated |
| Developer | Liability | Set Credit | Credit | Damage |
| C | 0.26 | 0 | 0.077 | 0.183 |
| D | 0.2 | 0 | 0.059 | 0.141 |
| Total | 0.46 | 0 | 0.136 | |

TABLE 5
Net Damage Summary

| | Net Damage | % Net Damage | Responsible |
|---|---|---|---|
| | Share | Liability Share | Entity |
| Baseline Traffic | 1.000 | 61% | Municipality |
| Permissive Damage Excess | 0.044 | 3% | Municipality |
| Permissive Margin | 0.136 | 8% | Municipality |
| Regulated Damage Credit | 0.136 | 8% | Municipality |
| Developer C | 0.183 | 11% | Developer C |
| Developer D | 0.141 | 9% | Developer D |
| Total Annual Damages | 1.640 | 100% | |

There is Permissive Damage Excess if the total damage caused by Unregulated Heavy Road Users (those whose damage line falls within the margin established by the Permissivity factor) is greater than the Permissive Margin, which in this case is 0.136. Any Unregulated Excess Permissive Damage is the responsibility of the municipality. However, even if there is Unregulated Excess Permissible Damage in a given year, because more developers were unregulated than expected, this can be offset in successive years if there are fewer developers than expected or no developers. This is because the annual margin, in the case of paved roads, is available each year of the life of the road since the Last Major Treatment. Therefore any excess developer ESALs not regulated in one year can be offset in the following year if there are fewer declared heavy road users or no declared heavy road users to consume the permissive and/or regulated margins. Table 4 also includes a column for Permissive Damage Offset Credit. If such a credit exists, which in this case it does not, it would be because the Permissive Margin is greater than the sum of Unregulated Heavy Users Damage. This Permissive Damage Offset Credit may then be added to the Regulated Margin and be used to offset the damage liability of any regulated developers. Also note that if the Permissivity Factor is 1.0 or greater, the regulated margin disappears. There is then only a Permissive Margin. All declared heavy road users whose damage is less than the Permissive Margin are then released from liability. However, all declared heavy road users whose damages are greater than the Permissive Margin become regulated. The developers would be credited, however, with a proportional share of the Permissive Damage Credit.

Table 5 summarizes the liability shares of the damages. The total damages for the year are 1.64. This includes the damage of the municipality and the four developers.

Notice that the damages of Developers A and B are accounted for in the total of the Permissive Margin and the Permissive Damage Excess. In this case, the municipality is liable for its damage (1.0), the Permissive Damage Excess (0.044), Permissive Margin (0.136), and the Regulated Margin (0.136). Developer C did 0.26 in damage however its share of the Regulated Margin reduced their Regulated Damage to 0.183. Similarly, Developer D caused damage of 0.20 which was reduced to 0.141 with its share of the Regulated Margin. The shares of regulated margin for Developers C and D were assigned proportionally based on the damage of each developer expressed as a percent of the combined damage of both of the regulated developers.

### Determining Capital Depreciation Liability Shares

In the final analysis, Developer C is responsible for 11% of the damage done during the RUA accountability period and Developer D is responsible for 9% of the damage. This is their Net Damage Liability Share. However, this is not the final percentage of the actual cost Developer C and D are responsible to pay of the repairs to be done. That is because there is still the issue of how much remaining life there is of the Last Major Treatment.

In general, the less remaining life there is then the less liability belongs to the Regulated Heavy Road Users, because the life already consumed and the damages already done were not their responsibility. However, this consideration applies only in the case of major rehabilitation and reconstruction (Capital Repairs) which add significant Structural Capacity to the pavement that can be measured in terms of a Structural Number. Major rehabilitation and reconstruction are considered capital projects, while routine maintenance and preventive maintenance are considered maintenance projects. Minor rehabs may or may not be considered capital projects, depending on the scope of the treatment. If they add structural capacity, such as a thin overlay, they too may be considered a capital repair and subject to Capital Depreciation Liability. In the case of maintenance projects, there is no Structural Capacity added to the pavement and the costs are relatively minor Therefore cost reimbursement is handled differently for capital projects versus maintenance projects.

In the case of Capital Projects the repair treatment that will be done will result in a Repaired Structural Capacity (SN_{R}) that is greater than the beforehand Structural Capacity (SN_{B}) that existed prior to the use by the Regulated Heavy Road Users. For the sake of illustration, it is assumed that a capital repair is needed at the end of the one-year analysis period. This assumption means that most of the useful life of the road was already consumed prior to the Heavy Road Users activity. Therefore, the municipality is responsible for most of the cost of the repair while the heavy road users bear a relatively minor responsibility. In fact, the heavy road users are only responsible for their contribution of damages that took the pavement from the SN_{B} to the Structural Number after their use (SN_{A}), keeping in mind, of course, that municipal baseline traffic was also part of the degradation of SN_{B} to SN_{A}. Degradation of the overall road structural number that occurred both before and during use by the developers is Capital Depreciation and the developers possess a portion of this which is termed their Capital Depreciation Liability Share. The following equations then indicate the percentage of the total regulated heavy road user Capital Depreciation Liability Share versus the Municipal share. This Capital Depreciation Liability Share belongs collectively to the regulated heavy road users and the municipality and is preferably proportioned in accordance with equations 9 and 10:

Heavy Road User Share=(SN_{B}−SN_{A})/(SN_{R}−SN_{A}) (9)

Municipal Share=(SN_{R}−SN_{B})/(SN_{R}−SN_{A}) (10)

In this case, consider that the SN_{B} was 2.0 and the SN_{A} was 1.0, while the SN_{R} is to be 3.0. The drop from SN_{B} of 2.0 to SN_{A} of 1.0 was caused by all four of the developers, of which only two were regulated, plus the municipal baseline traffic. More specifically Developer C is liable for 11% of the SN drop from 2.0 to 1.0, while Developer C is liable for 9% of it and the municipality is liable for 80% of it (reference Table 5). Since the municipality is requiring that the road repair achieve an SN of 3.0, the developers are not responsible for the increase of SN_{B} of 2.0 to SN_{R} of 3.0. In fact the need for the increase of SN_{B} to SN_{R} is actually due to the pre-existing capital depreciation prior to the road ever having been used by the developers. Therefore the municipality is liable for the upgrade of the SN from 2.0 to 3.0.

### Determining Total Cost Share

For a Capital project, the actual cost share of a given developer is preferably calculated by multiplying two factors, the Heavy Road User Capital Depreciation Liability Share and the Net Damage Liability Share.

Developer C Total Cost Share=50%×11%=5.5% (11)

where the Capital Depreciation Liability Share is 50% and the Net Damage Liability Share is 11%.

Developer D Total Cost Share=50%×9%=4.5% (12)

where the Capital Depreciation Liability Share (SN_{B} to SN_{A}) is 50% and the Net Damage Liability Share is 9%.

Municipal Total Cost Share=C₁+C₂ (13)

where C₁ is the Capital Depreciation Liability Share due to SN_{R} degradation to SN_{B} (SN_{R} must be built due to depreciation before the developers used the road) and C₂ is the Capital Depreciation Liability Share due to the drop of SN_{B} to SN_{A}

C₁=50% (14)

C₂=50%×(61%+3%+8%+8%) (15)

Municipal Total Cost Share=50%+50%×(61%+3%+8%+8%)=90% (16)

Then as a final check the sum of the Total Cost Liability Shares must be 100%:

Developer C Total Share (5.5%)+Developer D Total Share (4.5%)+Municipal Total Share (90%)=100% (17)

### Calculation of a Maintenance Repair Cost Share

In the case that the needed repair after developer use is only a maintenance project, then there is no structural improvement and therefore there is no SN_{R}. In this case, the only cost share factor involved is the Developer and the Municipality Damage Liability Share factors. If this were the case the cost shares would be as follows:
Developer C total Cost Share=11%
Developer D total Cost Share=9%

Municipal total Cost Share=61%+3%+8%+8%=80% (18)

Then as a final check the sum of the Total Cost Liability Shares must be 100%:

Developer C Total Share (11%)+Developer D Total Share (9%)+Municipal Total Share (80%)=100%

### Fishnet Analysis Procedure for Gravel Roads

In some embodiments, one or more of the following steps are performed in an analysis for gravel roads.

### Fishnet Damage Procedure for a Gravel Road

A gravel road analysis preferably considers only a 1-year current period of the road life. The current ADT is needed. However, the Fishnet Analysis Method for gravel roads considers two parameters related to damage including the ΔPSI and a maximum acceptable Rut depth. And, just as with paved roads, damage is a function of sub-grade strength variation. The approach for gravel roads preferably also includes creation of an Annual Damage Chart. However, since the AASHTO Gravel Roads Design method considers rut depth and ΔPSI as possible controlling criteria for gravel road performance, the method includes two equations, one that relates ΔPSI to needed gravel thickness and another that relates acceptable maximum rut depth to needed gravel thickness.

As with paved roads, this is typically a forensic reverse-engineering process. Normally, these equations are used to determine the needed gravel thickness for a road design. In this case, the gravel thickness is already in place on the roadway and the question is which parameter yields the least allowable ESALs for the 1-year study period, because that is the more conservative value to use for allowable ESALs. These equations are used to prepare a Gravel Road Damage Chart that relates damage to ESALs in order to select the controlling criteria for the fishnet analysis. The Chart preferably has two damage lines, one for Rut Depth and one for a specified Terminal Serviceability Index. The damage line that yields the fewest ESALs to consume 100% of the allowable damage is the line that governs and is then used for the Fishnet Regulatory analysis. The Gravel Road Damage Chart is preferably created by the following steps.

### Conduct a Forensic Investigation of the Proposed Haul Route

A minimum of four test pits or borings per mile are formed and tested to determine the in situ gravel layer types and thicknesses. Laboratory test results are conducted on all unique gravel specimens of each test pit. This information is reduced into a single common equivalent layer of gravel with an assigned thickness and an a-coefficient that best represents the 80^{th} percentile structural capacity of the gravel layers in all of the test pits. This is done by converting each gravel layer of each test pit into the equivalent thickness of an excellent gravel road using the standard AASHTO a-coefficient conversion graphs in the AASHTO Pavement Design Guide. Then, the various thicknesses from the test pits of this ‘equivalent representative gravel layer’ are analyzed statistically to calculate the 80^{th} percentile thickness. This ‘equivalent representative gravel layer’ is then used in the AASHTO Gravel Roads Design calculations outlined below.

### Estimation of the Sub-grade Resilient Modulus

Based on laboratory test results of specimens, an in situ sub-grade Resilient Modulus is determined An estimated resilient modulus for this sub-grade is determined for each month of the year, based on seasonal variation of sub-grade conditions, such as wetness and freeze-thaw. This is preferably done to be consistent with the AASHTO Gravel Roads Design method, which includes a table for regions of the country and the corresponding weather conditions relevant to sub-grade strength.

### Baseline ESALs Determination

A Present Baseline ESALs per Year is determined in the same manner as described above for paved roads.

### Calculation of Damages for Rut Depth and Change in Serviceability Index

Table 6 illustrates Rut Depth and ΔPSI Damage calculations. It is preferably created using the following information.

### Data for a Proposed Haul Route

The in situ gravel is 8 inches thick, of very good quality, and has an estimated a-coefficient of 0.10. This provides a Structural Number of 0.80 for the road. There is no sub-base gravel. The road is built on a clayey sub-grade with an estimated M_{R} of 4000 psi when dry.

The ADT count on the road yields 50 cars per day, 5 light trucks per day, 1 delivery van per day, 2 school buses per day, 1 tandem axle dump per day, and 8 tractor trailers per month. The total ESALs per year is therefore 2,924.

The ΔPSI selected is 2.5 and the maximum allowable rut depth selected is 2 inches.

Based on the AASHTO Gravel Roads Design method Table 2, climatic region III is selected. Based on the laboratory assessment of the clayey sub-grade the relative quality is determined to be very poor. Based on the AASHTO Gravel Roads Design method Table 3, the following seasonal M_{R} values and lengths of season are selected for the very poor roadbed sub-grade:
Winter (roadbed is frozen)—20,000 psi
Spring Thaw (roadbed is saturated)—1,500 psi
Spring/Fall (roadbed is wet)—2,500 psi
Summer (roadbed is dry)—4,000 psi
A Damage Table with the following columns is set up for a known Gravel Thickness of 8 inches:
   Column 1—Months of the year.
   Column 2—The Road Bed Resilient Modulus appropriate for the season.
   Column 3—The Elastic Modulus of the base gravel. Selected from test pits specimens and laboratory testing.
   Column 4—The projected municipal baseline ESALs for the 1-year study period.
   Column 5—The total ESALs the gravel layer could support to meet the ΔPSI of 2.5 if the sub-grade modulus remained at the assigned value for the month, indicated in Column 2 This value is determined by using the AASHTO Gravel Road Design Chart for Aggregate Surfaced Roads Considering Allowable Serviceability Loss appearing in the AASHTO Guide for Design of Pavement Structures.
   Column 6—The damage calculation for the ΔPSI of 2.5. It is calculated by dividing the value in Column 4 by the value in Column 5
   Column 7—The total ESALs the gravel layer could support to meet the allowable rut depth of 2 inches if the sub-grade modulus remained at the assigned value for the month, indicated in Column 2 It is determined by using the AASHTO Gravel Road Design Chart for Aggregate Surfaced Roads Considering Allowable Rutting appearing in the AASHTO Guide for Design of Pavement Structures.
   Column 8—The damage calculation for the allowable rut depth, calculated by dividing the value in Column 3 by the value in Column 5

FIG. 8 shows the Damage line for ΔPSI and allowable rutting. Damage is plotted on the y-axis and ESALs are plotted on the x-axis. The rut depth damage line is analyzed versus the Serviceability Index line. The line that yields the highest ESALs at the point where it crosses the horizontal damage line of 1.0 (the 100% damage consumed line) is discarded.

TABLE 6
Rut Depth and ΔPSI Damage
In-Situ Base Thickness 8 inches
In-Situ Base Elastic Modulus 25,000 Psi

| | | | | ΔPSI = 2.5 | | | |
|---|---|---|---|---|---|---|---|
| | | | Column 4 | Column 5 | | Allowable Rut Depth = 2.0 | |
| | Column 2 | | Projected | Allowable | | Column 7 | Column 8 |
| | Roadbed | Column 3 | 18-kip | 18-kip | Column 6 | Allowable 18-kip | Seasonal |
| Column 1 | Resilient | Base Elastic | ESAL | ESAL | Seasonal | ESAL traffic Rut | Damage Rut |
| Month | Modulus, psi | Modulus, psi | traffic | traffic PSI | Damage PSI | Depth | Depth |
| January | 20,000 | 25,000 | 833 | 400000 | 0.00208333 | 60,000 | 0.01388889 |
| February | 20,000 | 25,000 | 833 | 400000 | 0.00208333 | 60,000 | 0.01388889 |
| March (first 2 | 20,000 | 25,000 | 417 | 400000 | 0.00104167 | 60,000 | 0.006944444 |
| weeks) | | | | | | | |
| March (second | 1,500 | 25,000 | 417 | 2500 | 0.16886667 | 3,500 | 0.119047819 |
| 2 weeks) | | | | | | | |
| April | 1,500 | 25,000 | 833 | 2500 | 0.33333333 | 3,500 | 0.238035238 |
| May | 2,500 | 25,000 | 833 | 2780 | 0.3030303 | 6,000 | 0.138888888 |
| June | 4,000 | 25,000 | 833 | 7300 | 0.11415525 | 8,000 | 0.92592583 |
| July | 4,000 | 25,000 | 833 | 7300 | 0.11415525 | 9,000 | 0.92592583 |
| August | 4,000 | 25,000 | 833 | 7300 | 0.11415525 | 9,000 | 0.92592583 |
| September | 4,000 | 25,000 | 833 | 7300 | 0.11415525 | 9,000 | 0.92592583 |
| October | 2,500 | 25,000 | 833 | 2750 | 0.3030303 | 8000 | 0.01388889 |
| November | 2,500 | 25,000 | 833 | 2750 | 0.3030303 | 6000 | 0.01388889 |
| December | 2,500 | 25,000 | 833 | 2750 | 0.3030303 | 6000 | 0.01388889 |
| | | | | Total | 2.174 | Total | 1.318 |
| | | | | Damage | | Damage | |

In FIG. 8, the ΔPSI Damage Line controls, not the Rut Damage line. That is because the Annual ESAL Capacity of 4,650 is less than the Annual ESAL Capacity that would be given by the allowable rut depth damage line. Also, the existing annual base line traffic of 2,924 ESALs does not reach the annual ESAL capacity of 4,650.

Next the Margin is developed. Since ΔPSI is selected as the controlling criteria, the margin is created using a variation in the allowable ΔPSI. To create the margin, a second analysis is done for an allowable ΔPSI of 3.0 for example. This generates a ΔPSI damage line of lesser slope and more annual allowable ESAL Capacity. Alternatively, this is done with allowable rut depth, when rut depth is the controlling criteria.

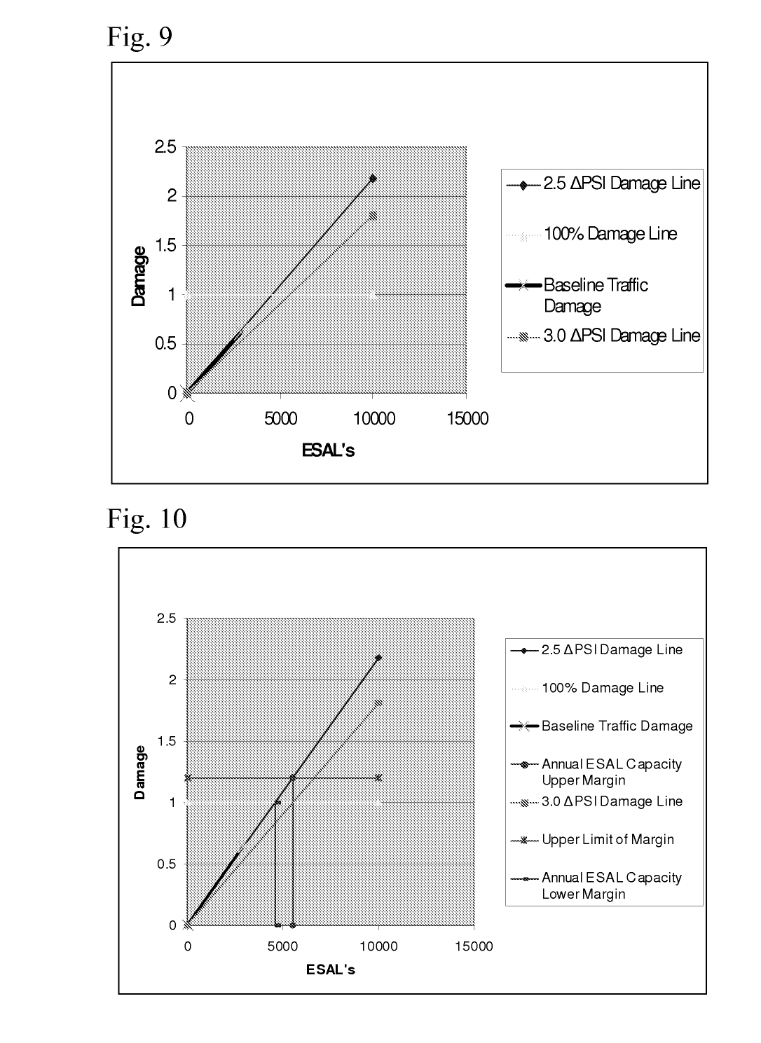

In FIG. 9 the rut depth damage line has been taken out and a second ΔPSI damage line for 3.0 added in to create the margin. The two ΔPSI damage lines are then used to define an allowable margin for developers as shown in FIG. 10. In addition, if desired, any excess capacity that exists, such as in this case, may be added to the allowable margin for heavy road users. Alternatively, any excess capacity that exists may be shared between the municipality and the regulated heavy road users.

### Defining the Gravel Road Fishnet

FIG. 10 shows a margin for the fishnet defined by the 1.0 damage line (100% damage) as the lower limit and an upper limit that has been defined by using the ΔPSI 3.0 damage line.

To construct the fishnet margin, the ΔPSI 2.5 damage line is first considered. This line intersects the 1.0 damage line at 4,650 ESALs. That means that at 4,650 ESALs, 100% of the allowable damage, based on monthly sub-grade conditions, is consumed when the ΔPSI 2.5 criteria is used. In order to create a margin, the ΔPSI 3.0 damage line is used. From the point of intersection of the 4,650 ESAL line, the ΔPSI 2.5 line and the 1.0 damage line move to the right, where the 1.0 Damage line intersects the ΔPSI 3.0 damage line. At this point, if a ΔPSI 3.0 is allowable, then the ESAL capacity increases to 5,500. This increase of 850 ESAL would cause approximately a 0.2 increase in damage relative to ΔPSI 2.5 criteria damage line. This is seen in the diagram as the vertical segment of the 5,500 ESAL line that is bounded by the intersection of the 5,500 ESAL line with the 1.0 damage line and the intersection of the 5,500 ESAL line with the ΔPSI 2.5 damage line. The upper limit of the margin is then defined by constructing a horizontal line that passes through the intersection of the 5,500 ESAL line and the ΔPSI 2.5 damage line. In essence, if the more generous criteria of ΔPSI 3.0 is used, then the damage above the 1.0 line would be enough to exceed the 1.0 damage line, along the ΔPSI 2.5 damage line, by 0.2. Note however, that if the ΔPSI 3.0 line were plotted on its own chart, the upper margin line, plotted on the ΔPSI 2.5 chart would actually represent a damage of 1.0 (100%). This relaxation of the ΔPSI criteria, by superimposing the ΔPSI 3.0 line on the ΔPSI 2.5 chart, therefore creates a margin of allowable extra ESALs and their associated damage per year that can be allotted to the use of developers. In this case the margin is 0.2 or about 20% more damage. Another way to explain this is to say that if 100% of damage exists for the ΔPSI 2.5 criteria, then if a ΔPSI 3.0 criteria were used, the same amount of traffic would cause 20% more damage for the ΔPSI 3.0 criteria relative to the damage caused for a more stringent ΔPSI 2.5 criteria.

It is also important to note here that the lower limit of the margin need not be the 1.0 damage line, if the base line traffic damage is less than 1.0. In such cases the additional damage capacity existing between the damage coefficient of the base line traffic and the 1.0 damage line may be used to lower the bottom margin line and increase the margin. In any case, wherever the bottom margin line is set, developer damage lines are plotted with their origin at the intersection of the ΔPSI line and the lower margin line, similar to the paved road fishnet analysis described above. If any gap is left between the damage coefficient of the base line traffic and the damage coefficient of the lower margin, then this amount of damage is left unconsumed by the municipality and in essence becomes an excess margin for the municipality base line traffic. In FIG. 10, this excess margin is about 0.35, since the lower limit of the margin in this example is set at the damage line of 1.0, and the baseline traffic damage reaches only about 0.65.

It is also important to note that a similar fishnet chart could be constructed using rut depth as the criterion in place of ΔPSI, if rut depth were the controlling criterion. An illustration of developer damage is presented in Table 7 showing the damage calculations for two Developers on a projected haul route.

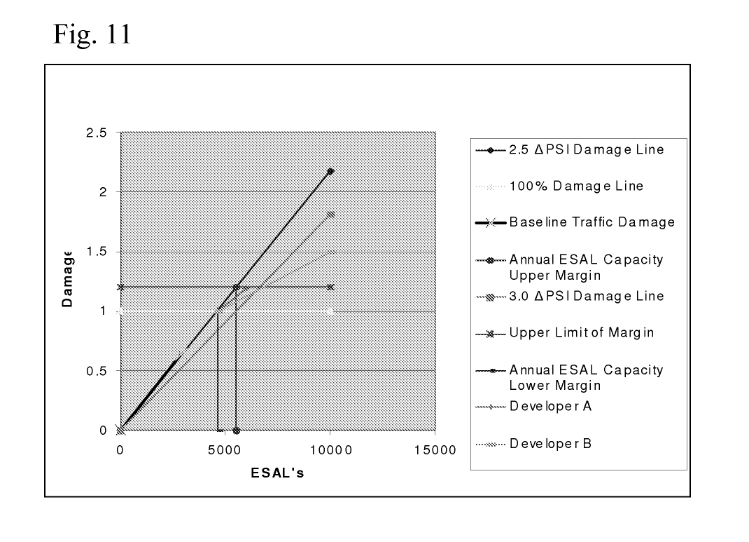

The chart in FIG. 11 indicates the developer damage lines calculated in Table 7. The lines are plotted such that they begin at the intersection of the ΔPSI 2.5 line with the lower margin line of 1.0.

TABLE 7
Developer Damage Calculations
Baseline Annual ESAL's 2.924 ESAL's
In-Situ Base Thickness 8 inches
In-Situ Base Elastic Modulus 25,000 psi

| | Column 2 | Column 3 | Column 4 | | ΔPSI = 2.5 | | |
|---|---|---|---|---|---|---|---|
| | Roadbed | Base Elastic | Developer A | Developer B | Column 5 | Developer A | Developer B |
| Column 1 | Resilient | Modulus, | Projected 18-kip | Projected 18-kip | Allowable 18-kip | Seasonal | Seasonal |
| Month | Modulus, psi | psi | ESAL traffic | ESAL traffic | ESAL traffic PSI | Damage PSI | Damage PSI |
| January | 20,000 | 25,000 | | 1000 | 400000 | 0 | 0.0025 |
| February | 20,000 | 25,000 | 500 | 1000 | 400000 | 0.00125 | 0.0025 |
| March (first 2 | 20,000 | 25,000 | 375 | 1350 | 400000 | 0.0009375 | 0.003375 |
| weeks) | | | | | | | |
| March (second | 1,500 | 25,000 | 475 | | 2500 | 0.19 | 0 |
| 2 weeks) | | | | | | | |
| April | 1,500 | 25,000 | | | 2500 | 0 | 0 |
| May | 2,500 | 25,000 | | 1000 | 2750 | 0 | 0.363636364 |
| June | 4,000 | 25,000 | | 1000 | 7300 | 0 | 0.136986301 |
| July | 4,000 | 25,000 | | | 7300 | 0 | 0 |
| August | 4,000 | 25,000 | | | 7300 | 0 | 0 |
| September | 4,000 | 25,000 | | | 7300 | 0 | 0 |
| October | 2,500 | 25,000 | | | 2750 | 0 | 0 |
| November | 2,500 | 25,000 | | | 2750 | 0 | 0 |
| December | 2,500 | 25,000 | | | 2750 | 0 | 0 |
| | | | 1350 | 5350 | Total Damage | 0.192 | 0.509 |

Developer A adds about 1350 ESALs of traffic to the road in the study period and the damage coefficient for this traffic is about 0.19, which is within the margin. This developer would not be regulated in this case. Developer B adds about 5,350 ESALs of traffic with an associated damage coefficient of 0.5. Developer B would be regulated.

### Determining Damage Liability Shares

Determining damage liability for gravel roads is analogous to the procedures already presented for paved roads. First, the distribution of liability is equitably assigned when there are multiple declared heavy road users using the same road. As with paved roads, a Permissivity Factor may also be used for gravel roads. The Permissivity factor may be set in the way as described for paved roads. The same calculations apply as presented in the paved roads discussion. For gravel roads major rehabilitation and reconstruction includes the addition of road structure through the placement of new gravel. As with paved roads, calculating cost shares for these treatments includes both the Regulated Heavy Road Users Damage Liability Share factor and the Capital Depreciation Liability Share factor.

Maintenance and preventive maintenance activities (such as grading, reshaping, and re-compacting) cost shares for gravel roads are preferably handled differently than paved roads however, since they will be needed during the actual course of use by the developer and are labor intensive. Also, dust control is very important when large numbers of truck trips are involved. Therefore, in general an RUA should stipulate a Gravel Roads Maintenance Policy that includes any routine and preventive maintenance effort over and above the normal scope of these treatments as provided by the highway agency are to be paid for by the heavy road users both during and after use by the heavy road users. Therefore, the damage coefficient caused by baseline traffic is not factored into the calculations for cost shares of routine and preventive maintenance. Rather, the municipality performs its normal maintenance activities and all extra needed activities are charged to the developers.

### Fishnet Analysis Procedures for Thin Bituminous Pavements (Surface Treatments)

Surface treated roads are defined as having 1-inch or less bituminous material over a granular base material. This category of road is found quite often among the road networks of municipalities, especially rural municipalities. These roads are neither “fish nor foul” as the old adage goes. In some respects they perform as pavements, and in other respects they perform as gravel roads. They behave as pavements in the sense that they do not experience the same dynamic gravel erosion processes as aggregate surfaced roads do, which comes as no surprise, since they were surface treated to prevent just such loss of gravel and to keep the public out of the mud. However, the bituminous material is so thin that it adds little to no inherent strength and this makes it somewhat of a poor fit with the philosophy of the AASHTO Paved Road Design equation, which is not very meaningful for structural numbers less than 1.0. Low traffic chip seal roads with 6 inches or so of granular base and a couple layers of chip seal do not qualify for a Structural Number greater than 1.0. Therefore, the recommended approach for thin bituminous pavements is to consider them from both the perspective of a gravel road and a paved road and then pick the controlling criterion, which will be either the Paved Road ΔPSI, the aggregate road ΔPSI, or the aggregate road rut depth criterion. Given this, it is not necessary to repeat here the tables, charts, and calculations presented above for paved and gravel roads. Rather, the intent of this section is to briefly explain how those same procedures are applicable to a thin bituminous pavement.

First, the preliminary steps are preferably the same. The forensic investigation starts off the process. However, as with gravel roads, no coring is needed. Test pits are excavated and samples are removed and tested in accordance with the same procedures explained for gravel roads. An ADT is conducted.

Next, the process is split into two parts. First, the road is processed exactly the same as for a paved road. The only difference is that the time of the Last Major Treatment is established as the middle of the period of years over which the build up of the surface treatments was placed on the road. The time of the Last Major Treatment is then established and the current ADT converted to that time, as explained previously for paved roads. A fishnet analysis is then conducted in accordance with the rest of the paved road fishnet procedures, and it is determined if the declared heavy users are regulated or not. The results are then set aside and the process is done again in accordance with the gravel road procedures. A determination of which heavy road users are regulated is made based on the gravel road procedures. The results are then compared. The more conservative results are used, that is, the results that generate the least Regulated Margin.

### Agricultural and Forestry Activity Exemptions

It is essential to note that agricultural and forestry activities are inherent activities of some municipal residents who are typically large contributors to the local tax base. Furthermore, local roads, especially in a rural community, are built and maintained in order to provide transportation services for farm to market activities inherently linked in a perpetual sense to the land tax base of the municipality. Therefore all agricultural activities should be exempted from regulation. Another reason for this is because agricultural activities provide for the most basic necessity of providing food, and thus are essential and life sustaining. Agricultural activities are also traditionally low profit margin activities and cannot sustain undue regulatory burdens, especially when those engaged in such activities already carry a proportionally large share of the municipal tax burden to begin with due large landholdings. Furthermore, agricultural activities happen on a regular and frequent basis throughout the year, making them part of the base line traffic. Forestry activities bear the common element that they are conducted on land owned by tax-payers. However, unlike agricultural activities that must be done routinely, logging operations can be selective about the time of the activity. Therefore, they should be conditionally exempted. The only condition is that they abide by municipal regulations that stipulate the weather conditions under which the logging traffic is permitted. In short, heavy logging traffic may appropriately be forbidden during times of saturation and high water tables. If the logging operation is not moved to a more favorable time, at the request of the municipality, then it is only fair that the activity should be regulated.

### Capital Upgrade Policy Prior to Use by a Declared Heavy Road User

Some roads may be of such low structural capacity that the pre-use forensic investigations determine a structural upgrade is needed so that the road can remain in a safe and passable condition throughout the heavy road use activity. In this case the first question is whether or not the road has already been programmed and budgeted for a capital repair. If so, the municipality should execute the repair and pay for it. However, if the municipality had the road on a deferred status then the municipality is put in the difficult position of not having the funding or capability to execute the upgrade. In this case, the heavy road user should be expected to execute and pay in full for the road upgrade. The procedure to evaluate if a road needs to be upgraded includes a traditional pavement design application, using for example, the AASHTO empirical flexible pavement design procedure, mentioned and used in the Fishnet Analytical Method presented herein.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method of regulating traffic usage of a road comprising the steps of:
a) monitoring traffic usage of the road;
b) determine a baseline annual equivalent single 18 kip axle load (ESAL) value for the road from the monitored traffic usage;
c) evaluating a condition of the road to determine a last major treatment structural number for the road comprising the sub-steps of:
i) determining a material type and a material thickness at a last major treatment of the road; and
ii) determining the last major treatment structural number at the last major treatment of the road using the material type and the material thickness;
d) evaluating and categorizing at least one potential heavy road user of the road as a regulated road user of the road; and
e) apportioning a portion of maintenance and repair costs for the road to the regulated road user based on the baseline ESAL value, the last major treatment structural number, and usage by the regulated road user.

2. A method of regulating heavy road traffic usage of a road comprising the steps of:
a) calculating a margin of capacity of the road; and
b) apportioning the margin as usage for at least one regulated road user of the road.

3. The method of claim 2, wherein step a) comprises the sub-steps of:
i) calculating a first lifetime equivalent single 18 kip axle load (ESAL) value from a first set of parameters for the road;
ii) calculating a second lifetime ESAL value from a second set of parameters for the road; and
iii) calculating the margin as a difference between the first lifetime ESAL value and the second lifetime ESAL value.

4. The method of claim 2, wherein step a) comprises the sub-steps of:
i) evaluating a baseline traffic pattern for the road; and
ii) calculating the margin as a percentage of the baseline traffic pattern.

5. A method of determining a last major treatment structural number for a road comprising the steps of:
a) digging a plurality of test pits in a plurality of predetermined locations in the road;
b) extracting a specimen of a natural subgrade layer, any granular road bed layers, and any bituminous and asphalt concrete material layers from each test pit and documenting a layer thickness and a layer condition for each layer;
c) extracting a plurality of core specimens in a plurality of predetermined locations in the road, if bituminous or asphalt concrete pavement is present;
d) evaluating each granular road bed layer and each bituminous and asphalt concrete material layer to determine a layer coefficient, a drainage coefficient, and a layer thickness for each granular road bed layer and each bituminous and asphalt concrete material layer of the road;
e) calculating a structural number for each granular road bed layer and each bituminous and asphalt concrete material layer of the road based on the layer coefficient, the drainage coefficient, and the layer thickness; and
f) selecting a minimum structural number from the plurality of structural numbers as the last major treatment structural number for the road.
